(19) United States
(12) Patent Application Publication
(10) Pub. No.: US 2022/0178958 A1
(43) Pub. Date: Jun. 9, 2022

(54) TAILORED SAMPLE HANDLING BASED ON SAMPLE AND/OR SAMPLE CONTAINER RECOGNITION

(71) Applicant: Beckman Coulter, Inc., Brea, CA (US)

(72) Inventors: Takayuki MIZUTANI, Edina, MN (US); Amit SAWHNEY, Minneapolis, MN (US); Iustin CORNEA, Burnsville, MN (US)

(21) Appl. No.: 17/509,288

(22) Filed: Oct. 25, 2021

Related U.S. Application Data
(63) Continuation of application No. PCT/US20/29803, filed on Apr. 24, 2020.
(60) Provisional application No. 62/838,990, filed on Apr. 26, 2019.

(51) Int. Cl. G01N 35/10

(52) U.S. Cl. CPC G01N 35/1002

(57) ABSTRACT

Systems and methods are provided for automatically tailoring treatment of samples in sample containers carried in a rack. The systems and methods may identify sample containers in the rack and/or detect various characteristics associated with the containers and/or the rack. This information may then be used to tailor their treatment, such as by aspirating and dispensing fluid from the sample containers in a way that accounts for the types of the samples/containers carrying them.

### RELATED APPLICATIONS

This is related to, and claims the benefit of, provisional patent application 62/838,990, titled “Tailored Sample Handling Based on Sample and/or Sample Container Recognition” filed in the United States Patent Office on Apr. 26, 2019. That application is hereby incorporated by reference in its entirety.

### BACKGROUND

A sample analyzer typically uses a sample presentation unit (SPU) for supporting and transferring a sample rack which holds a plurality of sample containers, such as sample tubes or cups. The analyzer will also generally include a pipettor that will remove a portion of the sample from a sample container in the SPU and transfer it to another sample container (e.g., sample vessel) on a sample wheel. Other pipettors may also be present, such as an additional pipettor that would transfer fluid from a sample vessel to another vessel (e.g., reaction vessel) on a carriage in a reaction build area in which it could be prepared for analysis, such as by being mixed with reagents and/or incubated.

While effective, analyzers such as described above may have various drawbacks. For example, as a result of sample container dead space, relying on multiple pipettors to transfer fluid from an original sample container in an SPU to the sample container where it will be prepared for analysis and/or where it would ultimately be analyzed can result in a reduction in the effective amount of a sample that is available for analysis. Additionally, analyzers that allow for special handling of particular samples generally require operators to manually specify that handling on a sample by sample basis, introducing a new potential source of error in each case where special handling may be appropriate.

### SUMMARY

In general terms, this disclosure is directed to differentially handling samples and their containers based on such recognition and/or other information that can be automatically perceived or otherwise determined by a laboratory instrument.

In a first aspect, the disclosure may be used to implement an automated clinical analyzer comprising a sample presentation unit and a computing device. In some such embodiments, the sample presentation unit may comprise a presentation lane. In some such embodiments the computing device may be configured to perform one or more acts selected from a set. In some such embodiments, the set of acts may comprise identifying a type for a sample container in the sample presentation lane based on an image of that sample container captured by a camera, and, based on that type, differentiate downstream processing for fluid contained in the sample container. In some such embodiments, the set of acts may comprise, based on identification information for the sample container in the sample presentation lane, determining a target location and transferring fluid from the sample container in the sample presentation lane to the target location.

In a second aspect, some embodiments as described in the context of the first aspect may comprise a set of one or more gantries. In some such embodiments, each gantry from the set of one or more gantries may be disposed at an angle relative to the presentation lane of the sample presentation unit, may be configured to translate a corresponding pipettor along its length and to cause the corresponding pipettor to aspirate or dispense fluids based on commands from the computing device, and may have a portion disposed above the presentation lane of the sample presentation unit. In some such embodiments, the computing device may be configured to, based on identification information for the sample container in the sample presentation lane, determine a first amount of fluid and determine the target location and transfer fluid from the sample container in the sample presentation lane to the target location. In some such embodiments, the computing device may be configured to transfer fluid from the sample container in the sample presentation lane to the target location by sending commands to a gantry from the set of one or more gantries adapted to cause that gantry to position its corresponding pipettor over the sample container in the sample presentation lane, aspirate the first amount of fluid from the sample container in the sample presentation lane, position its corresponding pipettor over the target location, and dispense a second amount of fluid from that gantry's corresponding pipettor into a vessel at the target location.

In a third aspect, in some embodiments as described in the context of the first aspect, the computing device may be configured to identify the type for the sample container in the sample presentation lane based on the image of that sample container captured by the camera and, based on the type, differentiate downstream processing for fluid contained in the sample container. In some such embodiments, the computing device may be configured to identify the type for the sample container based on container shape characteristics from the image captured by the camera.

In a fourth aspect, the disclosure may be used to implement a method of operating an automated clinical analyzer. In some such embodiments, the method could comprise presenting a sample container in a sample presentation lane of a sample presentation unit. In some such embodiments the method could comprise a computing device performing one or more acts selected from a set of acts. In some such embodiments, the set of acts could comprise identifying a type for the sample container in the sample presentation lane based on an image of that sample container captured by a camera and, based on the type, differentiating downstream processing for fluid contained in the sample container. In some such embodiments, the set of acts could comprise, based on identification information for the sample container in the sample presentation lane, determining a target location and transferring fluid from the sample container in the sample presentation lane to the target location.

In a fifth aspect, in some embodiments as described in the context of the fourth aspect, the analyzer may comprise a set of gantries. In some such embodiments, each gantry from the set of one or more gantries may be disposed at an angle relative to the presentation lane of the sample presentation unit, may be configured to translate a corresponding pipettor along its length and to cause the corresponding pipettor to aspirate or dispense fluids based on commands from the computing device, and may have a portion disposed above the presentation lane of the sample presentation unit. In some such embodiments, the computing device may be configured to, based on identification information for the sample container in the sample presentation lane, determine a first amount of fluid and determine the target location and transfer fluid from the sample container in the sample presentation lane to the target location. In some such embodiments, the computing device may be configured to transfer fluid from the sample container in the sample presentation lane to the target location by sending commands to a gantry from the set of one or more gantries adapted to cause that gantry to position its corresponding pipettor over the sample container in the sample presentation lane, aspirate the first amount of fluid from the sample container in the sample presentation lane, position its corresponding pipettor over the target location, and dispense a second amount of fluid from that gantry's corresponding pipettor into a vessel at the target location.

In a sixth aspect, in some embodiments as described in the context of the first aspect, the computing device may perform the act of identifying the type for the sample container in the sample presentation lane based on the image of that sample container captured by the camera and, based on the type, differentiating downstream processing for fluid contained in the sample container. In some such embodiments, the computing device may be configured to identify the type for the sample container based on container shape characteristics from the image captured by the camera.

In a seventh aspect, the disclosure may be used to implement a method of operating an analyzer in which the method comprises presenting a first sample container on a sample presentation lane of a sample presentation unit, and presenting a second sample on the sample presentation lane of the sample presentation unit. In some such embodiments, the method may further comprise using a camera to capture a first image, wherein the first image depicts the first sample container. In some such embodiments, the method may further comprise using the camera to capture a second image, wherein the second image depicts the second sample container. In some such embodiments, the method may comprise a computing device determining, based on the first image, a type for the first sample container. In some such embodiments, the method may comprise a computing device determining, based on the second image, a type for the second sample container. In some such embodiments, the method may comprise, based on the determined type for the first sample container, aspirating a first amount of fluid from the first sample container, wherein the first amount of fluid comprises an amount of fluid sufficient to perform an assay ordered for a sample in the first sample container and a dead space amount sufficient to fill dead space in an intermediate sample vessel. In some such embodiments, the method may comprise, based on the determined type for the second sample container, aspirating a second amount of fluid from the second sample container, wherein the second amount of fluid comprises an amount of fluid sufficient to perform an assay ordered for a sample in the second sample container but does not comprise the dead space amount sufficient to fill dead space in the intermediate sample vessel.

### BRIEF DESCRIPTION OF THE DRAWINGS

FIG. 1 is a top plan view of an example sample analyzer.

FIG. 2 depicts a perspective view of an exemplary rack installed at a first position in a sample presentation unit (SPU) of the sample analyzer of FIG. 1.

FIG. 3 depicts the perspective view of FIG. 2, but with the rack at a second position in the SPU.

FIG. 4 depicts the perspective view of FIG. 2, but with the rack at a third position where the rack is partially moved out of the second position of the SPU.

FIG. 5 is an elevation view of an example tube rack.

FIG. 6 is a perspective view of the tube rack of FIG. 5.

FIG. 7 is an elevation view of an example cup rack.

FIG. 8 is a perspective view of the cup rack of FIG. 7.

FIG. 9 is a perspective cut-away view of the tube rack of FIG. 5 with a plurality of sample tubes of different types.

FIG. 10 is a perspective view illustrating an example type of a sample cup.

FIG. 11 is a perspective view illustrating another example type of a sample cup.

FIG. 12 is a perspective view illustrating still another example type of a sample cup.

FIG. 13 is a perspective view illustrating yet another example type of a sample cup.

FIG. 14 is a perspective view of the tube rack located in a presentation lane of the SPU.

FIG. 15 is an enlarged portion of the perspective view of FIG. 14.

FIG. 16 is another perspective view of the tube rack located in the presentation lane of the SPU partially in view of a camera unit.

FIG. 17 is yet another perspective view of the tube rack located in the presentation lane of the SPU partially in view of a container detection unit.

FIG. 18 is an elevation view illustrating an example configuration of a camera unit with a mounting bracket.

FIG. 19 is a flowchart of an example method for performing sample container recognition with respect to a rack.

FIG. 20 is a schematic diagram illustrating different image positions for the rack.

FIG. 21A is a low exposure monochromatic image of a portion of a tube rack with sample tubes.

FIG. 21B is a low exposure monochromatic image of another portion of the tube rack with sample tubes.

FIG. 21C is a low exposure monochromatic image of yet another portion of the tube rack with sample tubes including one sample tube with a cap.

FIG. 22 is a low exposure monochromatic image of a portion of a cup rack with sample cups.

FIG. 23A is a high exposure monochromatic image of a portion of the tube rack with sample tubes.

FIG. 23B is the monochromatic image of FIG. 23A with bar codes of corresponding sample tubes identified.

FIG. 24 is a flowchart of another example method for performing sample container recognition with respect to a rack.

FIG. 25 is a flowchart of an example method for processing an image of a rack with one or more containers and determining characteristics of the containers therein.

FIG. 26 is the image of FIG. 21A with rack features identified.

FIG. 27 is the image of FIG. 21A with container features identified.

FIG. 28 is the image of FIG. 21A with container features identified.

FIG. 29 is the image of FIG. 21A with histogram features identified.

FIG. 30 is the image of FIG. 21C with histogram features identified.

FIG. 31 is an example classification table.

FIG. 32 is a monochromatic image of a portion of a cup rack with sample cups and showing histogram features identified.

FIG. 33 is a flowchart of an example method for adding and verifying a new container type for use with the sample analyzer.

FIG. 34 illustrates an exemplary architecture of a computing device that can be used to implement aspects of the present disclosure.

FIG. 35 is a low exposure monochromatic image of a portion of a tube rack with three sample tubes, two of which have cups inserted.

FIG. 36 is a low exposure monochromatic image of a portion of a cup rack with sample cups.

FIG. 37 is a flowchart of an example method for processing a sample in a tailored manner.

FIG. 38 illustrates differential treatment of samples in pediatric cups versus default treatment for an exemplary analyzer.

FIG. 39 illustrates a process for adding type specific instructions.

FIG. 40 illustrates a process for tailoring treatment of samples based on recognition that they are contained in pediatric cups.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

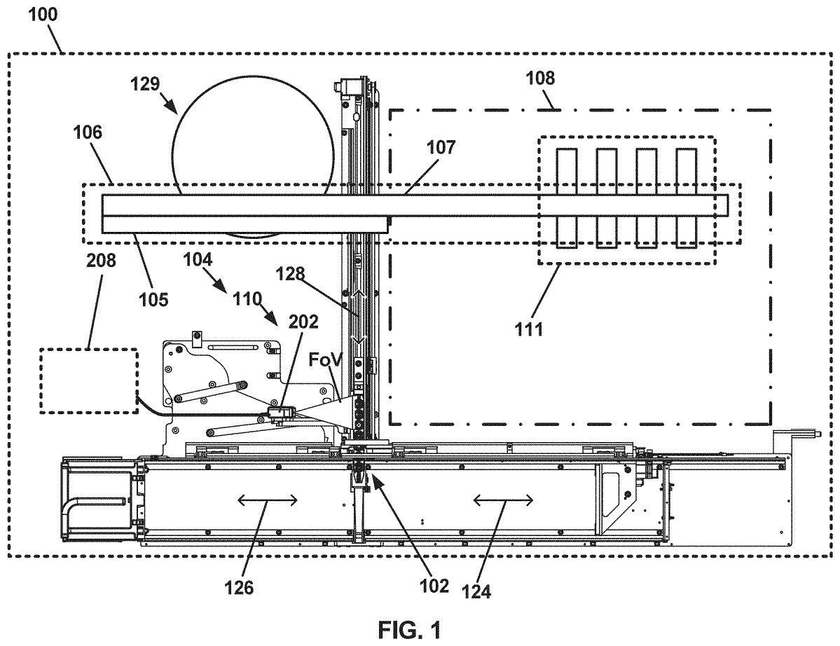

FIG. 1 is a top plan view of an example sample analyzer. In this example, the sample analyzer is generally designated as reference number 100 and configured to analyze a sample. The sample analyzer 100 includes a sample rack 102, a sample presentation unit (SPU) 104, a set of one or more gantries 106 which, in the preferred embodiment, is made up of a sample aliquot pipettor (and associated gantry) 105 and a sample precision pipettor (and associated gantry) 107, an analytic unit 108 including a reaction build area 111, and a sample container recognition unit 110.

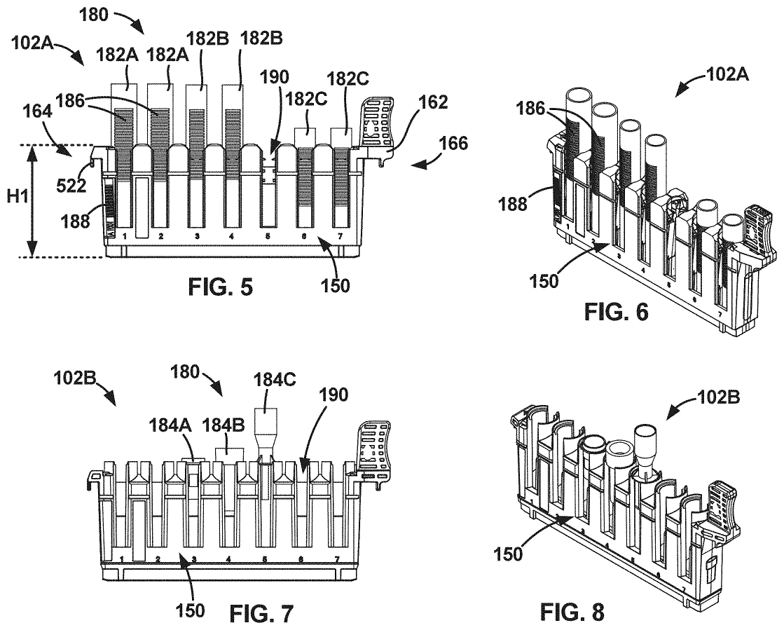

The rack 102 is configured to hold and transfer one or more sample containers 180. For example, the rack 102 can be used in various applications and configured to transfer one or more containers 180 within or outside the sample analyzer 100. As illustrated in FIGS. 5-8, one or more sample containers 180 can be positioned in the rack 102 in various combinations. As described herein, one or more sample containers 180 can be individually inserted and engaged with the rack 102. Although a single rack 102 is illustrated in this example, it is understood that the sample analyzer 100 is configured to support a plurality of racks 102, which can be used in various combinations in the sample analyzer 100 and operated either individually or in any combination.

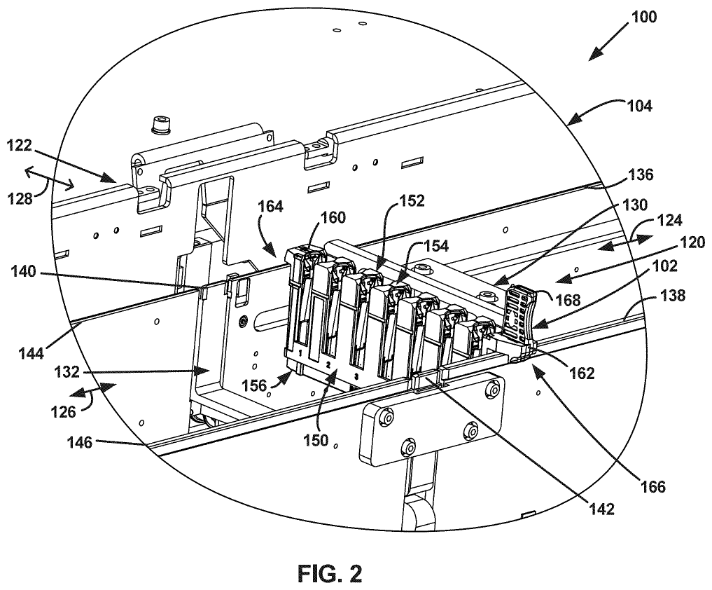

The SPU 104 operates to support the rack 102 and transfer the rack 102 to various locations. An example operation of the rack 102 is further described and illustrated with reference to FIGS. 2-9.

The set of one or more gantries 106 illustrated in FIG. 1 comprises two pipettors, a sample aliquot pipettor 105 and a sample precision pipettor 107, that can extract fluid from the sample containers in the rack 102. As shown in FIG. 1, the sample aliquot pipettor 105 will preferably be mounted on a gantry that intersects the rack presentation lane 128 as well as a sample wheel 129. In operation, the sample aliquot pipettor 105 would aspirate one or more aliquots (i.e., portions of a sample) along with sufficient additional fluid to account for dead space and fluid overdraw out of a sample container in the rack 102, and dispense each aspirated aliquot (along with additional fluid to account for dead space and overdraw) into new sample container in the sample wheel 129. Subsequently, when one of the aliquots was to be subjected to analysis, the sample precision pipettor 107 would aspirate the aliquot from the sample container in the sample wheel and dispense it into a reaction vessel in the reaction build area 111.

To illustrate, consider the case of an assay requiring 100 μL of fluid (e.g., a HBsAg assay). In some embodiments, to provide the necessary fluid, a sample aliquot pipettor could aspirate 182 μL from the sample container, representing the 100 μL necessary for the assay, plus a 5 μL expected overdraw for the sample precision pipettor, plus 60 μL to account for dead volume in the sample vessel, multiplied by 1.1 to provide an additional 10% overdraw margin for the sample aliquot pipettor itself. 165 μL of this aspirated fluid could then be dispensed into the sample vessel, while the additional 17 μL overdraw would remain in the sample aliquot pipettor's tip. The sample precision pipettor could then aspirate 105 μL of fluid from the sample vessel, and dispense the necessary 100 μL into the reaction vessel, while the 5 μL overdraw would remain in the sample precision pipettor's tip. The same type of procedure could be followed in the case where two aliquots of 100 μL were needed. Initially, the sample aliquot pipettor could aspirate 363 μL of fluid from the sample container, and 165 μL of this fluid could be dispensed into each of two sample vessels while 33 μL would remain in the sample aliquot pipettor's tip as overdraw. The sample precision pipettor could then aspirate 105 μL from the first sample vessel and dispense 100 μL to a first reaction vessel, and aspirate 105 μL from the second sample vessel and dispense 100 μL to a second reaction vessel.

Additionally, in some embodiments, a sample precision pipettor 107 may be mounted on a gantry that intersects not only the sample wheel 129, but also the rack presentation lane 128. In these types of embodiments, the sample precision pipettor 107 and its associated gantry may be configured to allow the sample precision pipettor 107 to aspirate fluid directly from a sample container in the rack 102. In some embodiments where this functionality is present, it may allow for a sample to be transferred directly from the original sample container to a vessel in the reaction build area 111, thereby avoiding losing any fluid to dead space in an intermediate sample vessel in the sample wheel 129. For example, in the case of an assay requiring 100 μL of fluid the sample precision pipettor could aspirate 105 μL and dispense 100 μL directly into the reaction vessel, avoiding lost volume due to sample vessel dead space or the sample aliquot pipettor's overdraw.

Of course, it should be understood that, while the analyzer illustrated in FIG. 1 includes multiple pipettors, this type of multiple pipettor configuration may not be utilized in all embodiments. For example, in some embodiments, there may be only a single pipettor mounted on a gantry that intersects the sample wheel 129, the rack presentation lane 128 and the reaction build area 111. Accordingly, the discussion set forth above should be understood as being illustrative only, and should not be treated as limiting.

In addition to including the reaction build area 111 mentioned previously, the analytic unit 108 operates to analyze the samples originally introduced to the sample analyzer 100 in the containers 180 on the racks 102. The analytic unit 108 includes subsystems to transfer vessels, dispense reagents into reaction vessels, incubate, mix, wash, deliver substrate, and read the chemiluminescence reaction light intensity.

The sample container recognition unit 110 operates to recognize types of containers 180 in the racks 102. An example of the sample container recognition unit 110 is illustrated and described herein.

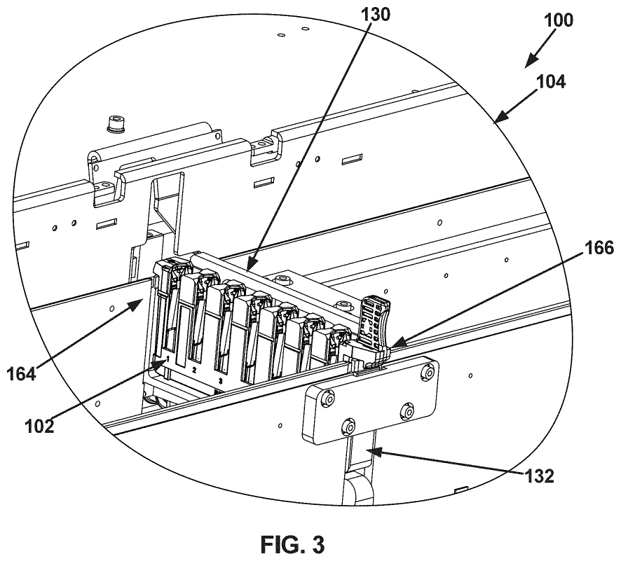

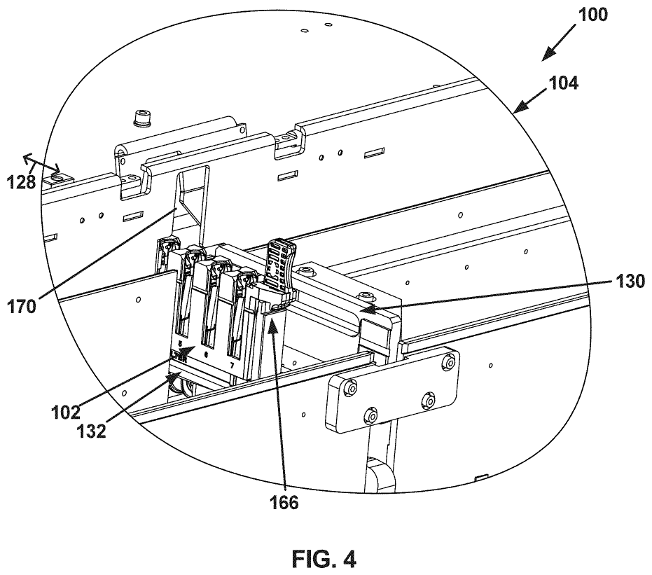

Referring to FIGS. 2-4, an example operation of the rack 102 is illustrated, which holds and transfers one or more sample containers 180 in the sample analyzer 100. In particular, FIG. 2 depicts a perspective view of an exemplary rack 102 installed at a first position in the SPU of the sample analyzer 100. FIG. 3 depicts the perspective view of the rack at a second position in the SPU, and FIG. 4 depicts the perspective view of the rack at a third position where the rack is partially moved out of the second position of the SPU. As described below, the rack 102 is located in an onload lane 124 in FIG. 2, at an intersection of the onload lane 124 and a presentation lane 128 in FIG. 3, and in the presentation lane 128 in FIG. 4.

In some embodiments, the rack 102 is loaded with one or more sample containers 180 before the rack 102 is loaded into the sample analyzer 100 (e.g., the SPU 104 thereof). In other embodiments, the rack 102 is loaded with one or more sample containers 180 after the rack 102 has been loaded into the sample analyzer 100 (e.g., the SPU 104 thereof). In yet other embodiments, the rack 102 is partially loaded with one or more sample containers 180 before the rack 102 is loaded into the sample analyzer 100, and one or more additional sample containers 180 can be loaded into the rack 102 afterwards.

The SPU 104 operates to transfer the rack 102, thereby transferring the sample containers 180 held in the rack 102. In some embodiments, the SPU 104 is configured to transfer the rack 102 to various locations or stations in the sample analyzer 100. As illustrated in FIG. 2, the SPU 104 includes a lateral movement section 120 (i.e., an onload-offload lane) and a transverse movement section 122 (i.e., a presentation lane). As depicted, the lateral movement section 120 is substantially perpendicular to the transverse movement section 122. The lateral movement section 120 includes an onload lane 124 and an offload lane 126. A presentation lane 128 of the transverse movement section 122 is positioned between the onload lane 124 and the offload lane 126.

In some embodiments, the lateral movement section 120 includes a pusher 130 to advance the rack 102 along the onload lane 124 and the offload lane 126. The transverse movement section 122 includes a carrier 132 to advance the rack 102 along the presentation lane 128. The onload lane 124 includes a first rail 136 (i.e., onload back rail) and a second rail 138 (i.e., onload front rail). The presentation lane 128 includes a third rail 140 (i.e., a carrier back rail, a first hook holder, etc.) and a fourth rail 142 (i.e., carrier front rail, a second hook holder, etc.). The offload lane 126 includes a fifth rail 144 (i.e., offload back rail) and a sixth rail 146 (i.e., offload front rail). The first rail 136 and the fifth rail 144 are aligned with each other. Likewise, the second rail 138 and the sixth rail 146 are aligned with each other and are substantially parallel to the first rail 136 and the fifth rail 144. When the carrier 132 is at a receiving position (e.g., see FIG. 2), the third rail 140 is aligned with the first rail 136 and the fifth rail 144, and the fourth rail 142 is aligned with the second rail 138 and the sixth rail 146.

The rack 102 can include a mounting feature configured to load the rack 102 into the SPU 104. In some embodiments, the mounting feature includes a first hook 160 arranged at a first end 164 and a second hook 162 arranged at a second end 166 opposite to the first end 164. To load the rack 102 into the SPU 104, the first hook 160 is engaged with the rail 136, 140, and/or 144, and the second hook 162 is engaged with the rail 138, 142, and/or 146. To facilitate placing the rack 102 into the SPU 104, a handle 168 (see, e.g., FIG. 2) is provided to the rack 102 and may be manually grasped by an operator. In some embodiments, the rack 102 may be loaded into the SPU 104 via automated means (e.g., by a robot, a pick-and-place apparatus, etc.), though it is also possible that, in some embodiments, the rack 102 may be loaded manually. It is also possible that some embodiments may support both automated and manual loading (e.g., a first side of an analyzer, such as its left, may have an automation connection for automated loading, while a second side of the analyzer, such as its front, may provide a back-up option for manual loading in the cause of an automation malfunction).

When a plurality of the racks 102 are held by the SPU 104, the racks 102 are typically loaded into the SPU 104 at the onload lane 124. The racks 102 may thus be stacked within the SPU 104. For example, a front 150 of one of the racks 102 may abut a rear 152 of another of the racks 102. Where more than two of the racks 102 are held by the SPU 104, the front 150 of one of the racks 102 may abut the rear 152 of another of the racks 102 positioned ahead of it, and the rear 152 of the one of the racks 102 may abut the front 150 of another of the racks 102 positioned behind it. A pattern of abutting racks 102 may thus be formed into a stack. A rear 152 of a rearmost rack 102 may abut the pusher 130.

One or more of the racks 102 may be loaded into the SPU 104 at a time. For example, the first hook 160 may be engaged with the rail 136, and the second hook 162 may be engaged with the rail 138 to load the racks 102 into the onload lane 124. If needed, (e.g., when others of the racks 102 are already positioned within the SPU 104), the pusher 130 may be retracted (e.g., moved away from the already positioned racks 102) and thereby make room for the newly added rack(s) 102. Upon the one or more of the racks 102 being loaded into the SPU 104, the pusher 130 may be advanced (e.g., moved toward the racks 102) and thereby remove any excess room between the pusher 130 and the rack(s) 102. One or more of the racks 102 may be loaded into the SPU 104 ahead of, in the middle of, or behind the rack(s) 102 already positioned within the SPU 104.

To move the rack(s) 102 (thereby moving the sample containers loaded thereon) through/into the sample analyzer 100, the pusher 130 may advance the rack(s) 102 and thereby position at least one of the rack(s) 102 into the presentation lane 128 when the carrier 132 is at the receiving position (e.g., see movement between FIGS. 2 and 3). Upon moving from the onload lane 124 to the presentation lane 128, the first hook 160 transfers engagement from the rail 136 to the rail 140, and the second hook 162 transfers engagement from the rail 138 to the rail 142. To further move the rack(s) 102 (thereby further moving the sample containers) through/into the sample analyzer 100 (e.g., through a gate 170 in FIG. 4), the carrier 132 may advance from the receiving position and thereby advance at least one of the rack(s) 102 along the presentation lane 128 (e.g., see movement between FIGS. 3 and 4) further into the sample analyzer 100. Upon reaching a predetermined position within the sample analyzer 100, sample(s) within one or more sample containers may be withdrawn and/or otherwise processed and/or analyzed by and/or within the sample analyzer 100.

To remove the rack(s) 102 (thereby removing the sample containers loaded thereon) through/from the sample analyzer 100, the carrier 132 may retract from the predetermined position to the receiving position and thereby withdraw the at least one of the rack(s) 102 along the presentation lane 128 (e.g., see movement between FIGS. 4 and 3) from the sample analyzer 100. To reach the receiving position (e.g., through the gate 170 in FIG. 4), the carrier 132 positions the at least one of the rack(s) 102 along the lateral movement section 120. The pusher 130 may then advance the rack(s) 102 and thereby position the at least one of the rack(s) 102 into the offload lane 126 when the carrier 132 is at the receiving position (e.g., see movement between FIGS. 2 and 3, but with the pusher 130 or a stack of the racks 102 pushing the at least one of the rack(s) 102 out of the carrier 132 and into the offload lane 126). Upon moving from the presentation lane 128 to the offload lane 126, the first hook 160 transfers engagement from the rail 140 to the rail 144, and the second hook 162 transfers engagement from the rail 142 to the rail 146. To further move the rack(s) 102 (thereby further moving the sample containers) through/from the sample analyzer 100, additional rack(s) 102 may be similarly ejected from the carrier 132 into the offload lane 126 and thereby push the at least one of the rack(s) 102 along the offload lane 126. The racks 102 may similarly be driven off of an end of the offload lane 126 (e.g., into a waste receptacle) and thereby be unloaded from the sample analyzer 100.

Alternatively, to unload the rack 102 from the SPU 104, the first hook 160 may be disengaged from the rail 136, 140, and/or 144, and the second hook 162 may be disengaged from the rail 138, 142, and/or 146. To facilitate removing the rack 102 from the SPU 104, the handle 168 may be manually grasped by the operator. The rack 102 may be unloaded from the SPU 104 via manual or automated means (e.g., by a robot, a pick-and-place apparatus, etc.). A plurality of the racks 102 may be simultaneously held by the offload lane 126 (similar to the onload lane 124). The racks 102 are typically unloaded from the SPU 104 at the offload lane 126.

Referring to FIGS. 5-8, examples of the rack 102 are illustrated, which is loaded with containers 180. In particular, FIG. 5 is an elevation view of an example tube rack, and FIG. 6 is a perspective view of the tube rack of FIG. 5. FIG. 7 is an elevation view of an example cup rack, and FIG. 8 is a perspective view of the cup rack of FIG. 7.

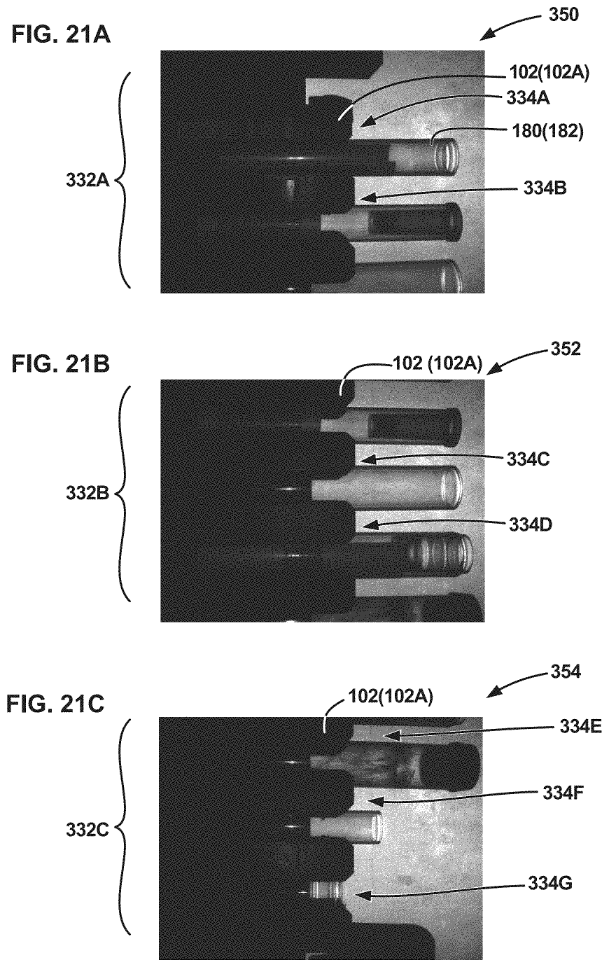

The rack 102 includes rack slots 190 which can be loaded with containers 180. The rack slots 190 can define container positions 334 as illustrated in FIG. 21A-21C below.

In some embodiments, the rack 102 includes a tube rack 102A as illustrated in FIGS. 5 and 6. In the illustrated example, the tube rack 102A is loaded tubes 182 (i.e., examples of the containers 180) having different sizes, such as first tubes 182A, second tubes 182B, and third tubes 182C. In this example, one of the rack slots 190 is left empty in the tube rack 102A. As described herein, different types of tubes 182 can be identified by the sample container recognition unit 110.

In other embodiments, the rack 102 includes a cup rack 102B as illustrated in FIGS. 7 and 8. In the illustrated example, the cup rack 102B is loaded with cups 184 (i.e., examples of the containers 180) having different sizes, such as a first cup 184A, a second cup 184B, and a third cup 184C. In this example, four of the rack slots 190 are left empty in the cup rack 102B. As described herein, different types of cups 184 can be identified by the sample container recognition unit 110.

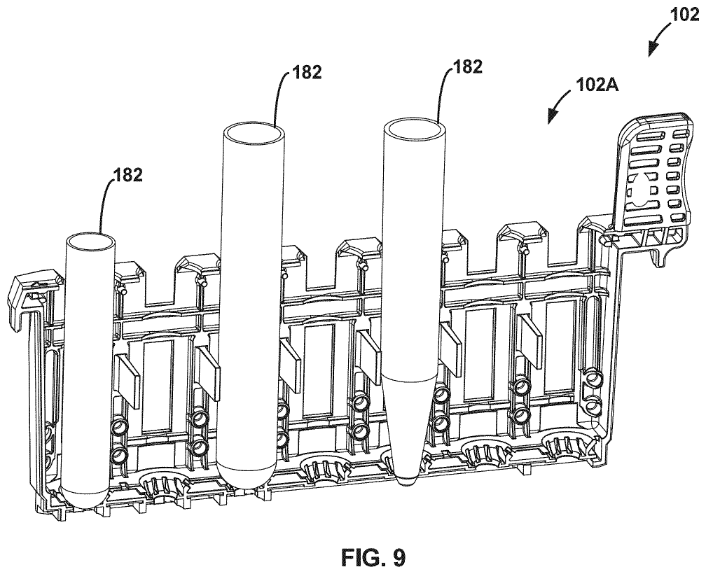

FIG. 9 is a perspective cut-away view of the rack 102, such as a tube rack 102A of FIGS. 5 and 6, which holds various types of sample tubes 182. As illustrated, the tube rack 102A is configured to receive sample tubes 182 of different dimensions.

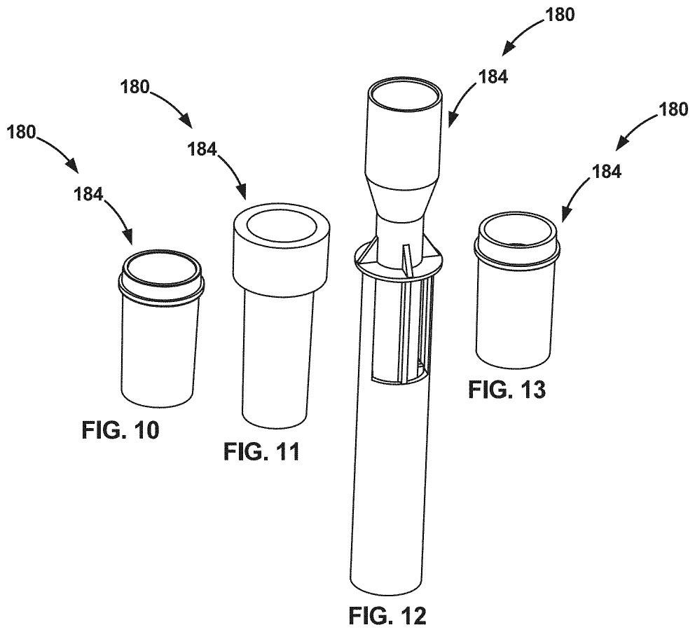

FIGS. 10-13 illustrate various types of sample cups 184. As illustrated, sample cups 184 may be of various types, and the cup rack 102B is configured to receive such sample cups 184 of different dimensions.

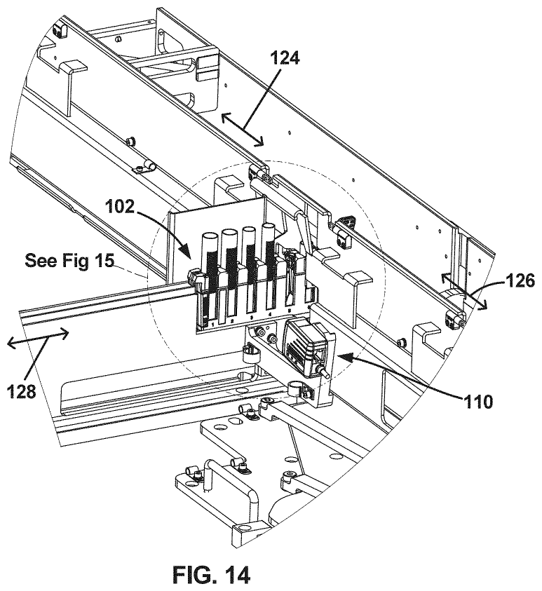

Referring to FIGS. 14-18, an example of the sample container recognition unit 110 is described with respect to the rack 102. In FIGS. 14-18, the sample container recognition unit 110 is primarily illustrated with respect to the tube rack 102A. It is understood, however, that the sample container recognition unit 110 can also be used and operated similarly with respect to the cup rack 102B.

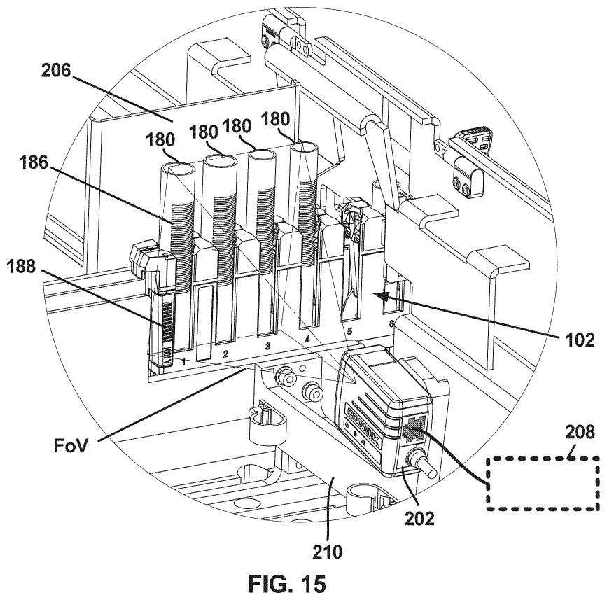

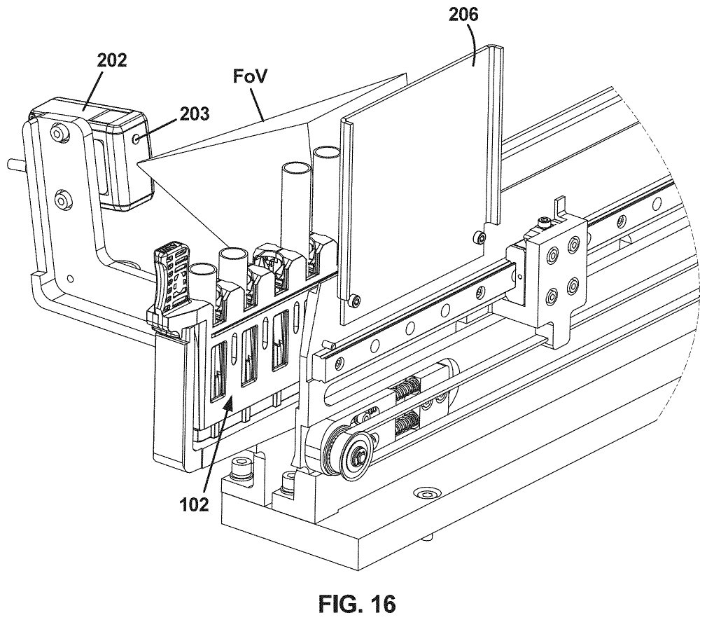

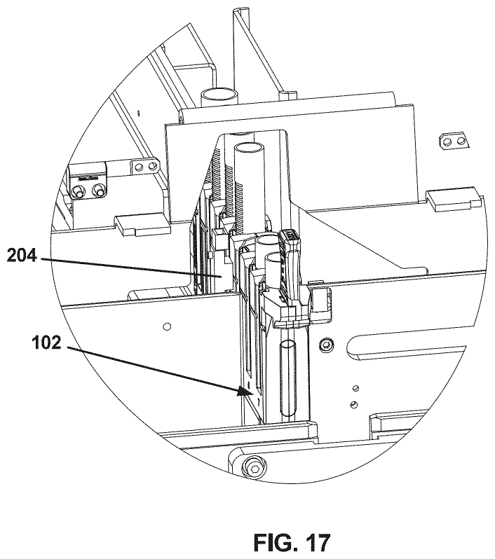

In particular, FIG. 14 is a perspective view of the tube rack 102 located in the presentation lane 128 of the SPU 104. FIG. 15 is an enlarged view of the tube rack 102 of FIG. 14. In FIGS. 14 and 15, the tube rack 102 is shown partially in view of a camera unit of the sample container recognition unit 110. FIG. 16 is another perspective view of the tube rack 102 located in the presentation lane 128 of the SPU 104 partially in view of the camera unit of the sample container recognition unit 110. FIG. 17 is yet another perspective view of the tube rack 102 located in the presentation lane 128 of the SPU 104 partially in view of a container detection unit of the sample container recognition unit 110.

The sample container recognition unit 110 operates to identify the containers 180 in the rack 102 and detect various characteristics associated with the containers 180, which are used to determine the types of the containers 180. For example, the sample container recognition unit 110 operates to detect a container identifier 186 such as a barcode or a QR code provided to a container 180. The container identifier 186 is used to verify the container 180 in the rack 102, as described herein. The container identifier 186 can be provided to any suitable location of the container 180. In the illustrated examples of FIGS. 5, 6, and 15, the container identifier 186 is provided to an exterior of the sample tube 182. The container identifier 186 can be similarly provided to an exterior of the sample cup 184.

In addition, the sample container recognition unit 110 operates to identify the rack 102. For example, the sample container recognition unit 110 operates to detect a rack identifier 188, such as a barcode or QR code provided to the rack 102. The rack identifier 188 is used to verify the rack 102 as described herein. The rack identifier 188 can be provided to any suitable location of the rack 102. In the illustrated examples of FIGS. 5, 6, and 15, the rack identifier 188 is arranged on the front of the rack 102 adjacent to the first end 164 of the rack 102. Other locations in the rack 102 are also possible for the rack identifier 188. The rack identifier 188 can be provided on the tube racks 102A and/or the cup racks 102B.

In some embodiments, the sample container recognition unit 110 includes a camera unit 202, a container detection unit 204, a screen 206, and a computing device 208. The camera unit 202 can be secured to the SPU 104 using a mounting bracket 210.

The camera unit 202 operates to detect and identify the rack 102 and the containers 180 in the rack 102, and determine characteristics of the rack 102 and the containers 180 therein. Such characteristics of the containers 180 can be used to identify types of the containers 180, as discussed herein. The camera unit 202 is arranged in front of the rack 102 that is movable relative to the camera unit 202.

As described herein, the camera unit 202 can operate to read identifiers associated with the rack 102 and the containers 180 therein. Further, the camera unit 202 operates to locate, analyze, and inspect the rack 102 and the containers 180 therein. The camera unit 202 can be connected to the computing device 208 for various processes. One example of the camera unit 202 includes ADVANTAGE 100 SERIES, which is available from Cognex Corporation (Natick, Mass.).

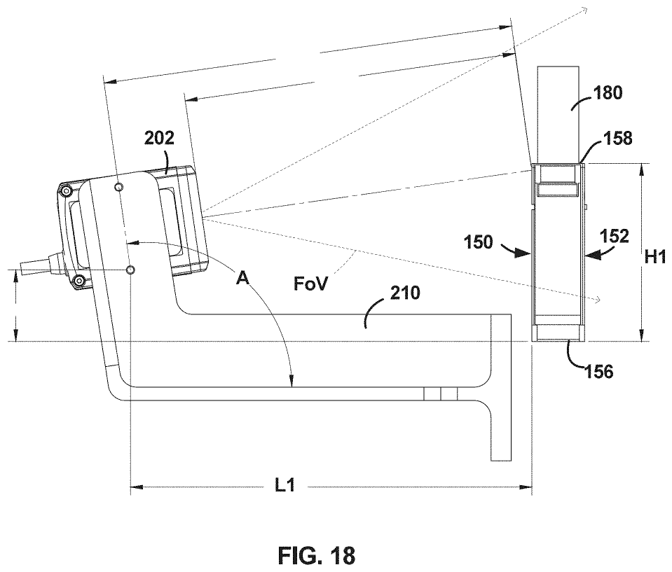

The camera unit 202 can be supported in the sample analyzer 100 with the mounting bracket 210. The mounting bracket 210 is configured to space the camera unit 202 from the rack 102 and to position the camera unit 202 relative to transient location(s) of the rack 102 to enable the camera unit 202 to have a field of view (FOV) on the container 180 and/or rack 102 being examined. An example of the mounting bracket 210 is further described and illustrated with reference to FIG. 18.

The camera unit 202 can include a light source 203, such as a LED light, which is operable to emit light toward the rack 102 (and toward the screen 206). The screen 206 is used to cast light back in the direction of the field of view (FOV) of the camera unit 202 by reflecting light toward the camera's aperture. One example of the camera unit 202 includes a model named ADVANTAGE 102, such as part number ADV102-CQBCKFS1-B, which is available from Cognex Corporation (Natick, Mass.).

The container detection unit 204 operates to detect whether a container 180 is present in the rack 102. The container detection unit 204 is arranged to scan the rack 102 as the rack 102 moves relative to the container detection unit 204. In the illustrated example, the container detection unit 204 is arranged at one side of the rack 102 while the other side of the rack 102 faces the camera unit 202. As described herein, the container detection unit 204 can detect the rack 102 partially or entirely and determine whether any container position (e.g., the container positions 334 as illustrated in FIGS. 21A-21C) of the rack 102 is empty or not.

Various sensors can be used for the container detection unit 204. In some examples, the container detection unit 204 includes a photosensor of various types. For example, the container detection unit 204 includes a reflector-type photosensor (also referred to as a reflective photointerrupter or a photoreflector), which positions a light emitting element and a light receiving element on the same surface (so that they face the same direction) and is configured to detect presence and position of an object based on the reflected light from a target object. One example of such a reflector-type photosensor is GP2A25J0000F Series, which is available from Sharp Corporation (Osaka, Japan). Other types of photosensors can also be used for the container detection unit 204, such as a photointerrupter (also referred to as a transmission-type photosensor), which consists of a light emitting element and a light receiving element aligned facing each other in a single package, and which works by detecting light blockage when a target object comes between both of the elements.

The screen 206 is arranged and used with the camera unit 202 to improve image capturing of the camera unit 202. The screen 206 is arranged to be opposite to the camera unit 202 so that the rack 102 is positioned between the camera unit 202 and the screen 206. The screen 206 is used to cast light back in the direction of the field of view (FOV) of the camera unit by reflecting light toward the camera's aperture.

The screen 206 is made of one or more various materials which can provide different reflection intensities. Further, the screen 206 includes a material configured to increase a scanning range of barcodes or other identifiers. For example, the screen 206 includes a retroreflective sheeting, one example of which includes 3M™ Scotchlite™ Sheeting 7610, available from 3M Company (Maplewood, Minn.).

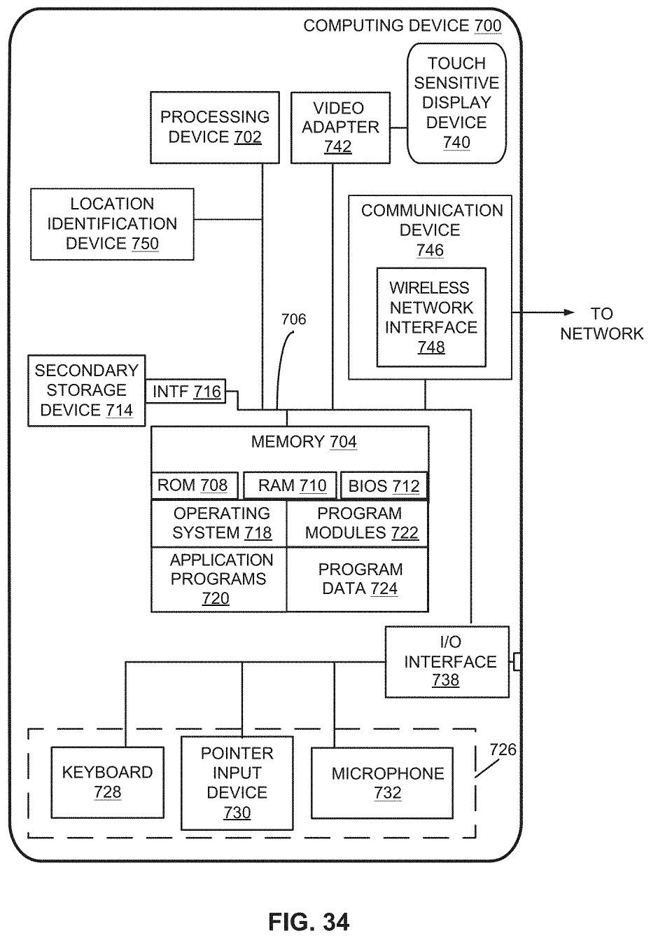

The computing device 208 is connected to the camera unit 202 and operates to process the data transmitted from the camera unit 202, such as image processing and evaluation. In addition, the computing device 208 is connected to the container detection unit 204 and operates to detect whether a container is present in the rack. The computing device 208 can include at least some of the components included in an example computing device as illustrated and described with reference to FIG. 34.

In some embodiments, the computing device 208 executes a software application that processes and evaluates images from the camera unit 202 and determines various characteristics associated with the rack 102 and/or the containers 180 in the rack 102. One example of such a software application is Cognex In-Sight Vision Software, available from Cognex Corporation (Natick, Mass.), which provides various tools, such as edge detection (“Edge”), pattern matching (“Pattern Match”), histogram analysis (“Histogram”), and barcode detection (“ReadIDMax”). In other embodiments, the camera unit 202 may be a smart camera that can determine such characteristics itself, in which case such characteristics would be provided to the computing device 208 for use in its further processing. An example of such a smart camera is the Advantage 102 from Cognex Corporation (Natick, Mass.).

Referring to FIG. 18, the mounting bracket 210 is configured to arrange the camera unit 202 in front of the rack 102 and to face the front 150 of the rack 102. The camera unit 202 is spaced apart from the front 150 of the rack 102 at a distance Li, which can range from about 100 mm to about 200 mm while the rack 102 has a height H1 which can range from about 50 mm to about 100 mm. The height H1 of the rack 102 can be defined as a distance between a bottom 156 and a top 158 of the rack 102 (see also FIG. 5). In some embodiments, the mounting bracket 210 is configured to support the camera unit 202 at an angle A relative to the bottom 156 of the rack 102 such that the field of view (FOV) covers the entire height of the containers 180 received in the rack 102. The angle A can range from about 90 degrees to about 120 degrees, in some embodiments. Other ranges for the distance Li, the height H1, and the angle A are also possible in other embodiments.

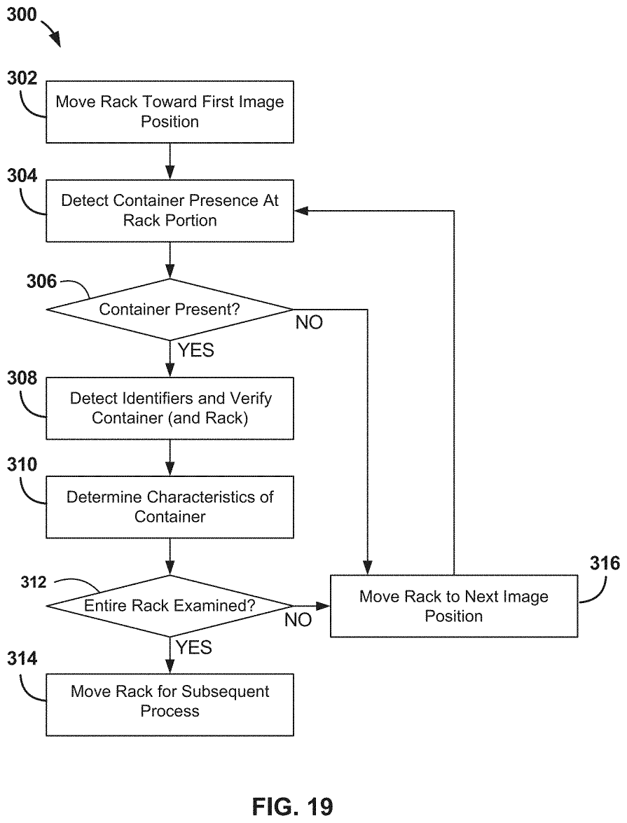

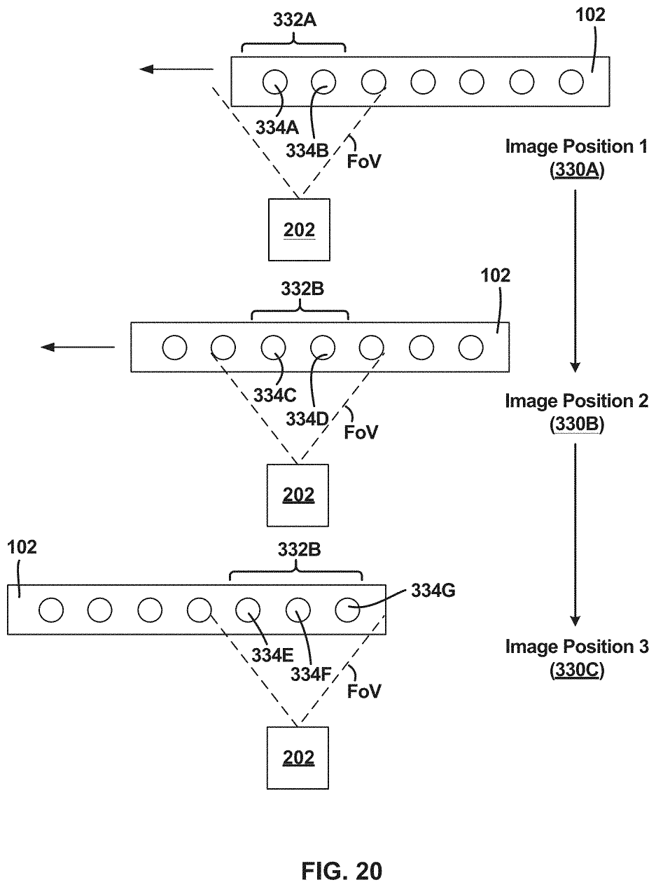

FIG. 19 is a flowchart of an example method 300 for performing sample container recognition with respect to a rack 102. In some embodiments, the method 300 can be at least partially performed by the sample container recognition unit 110 with associated devices in the sample analyzer 100. The method 300 is described with reference also with FIGS. 20-23.

The method 300 can start at operation 302 in which the rack 102 is operated to move toward a first image position 330A with respect to the sample container recognition unit 110.

The rack 102 is movable to a plurality of predetermined image positions 330 relative to the sample container recognition unit 110 so that different portions of the rack 102 are viewed and captured by the sample container recognition unit 110. For example, the camera unit 202 of the sample container recognition unit 110 can have a field of view (FOV) that is limited to only a portion of the rack 102. Therefore, to examine the entire rack 102 (i.e., all rack slots 190 of the rack 102), the rack 102 is moved relative to the camera unit 220 so that the camera unit 220 captures a plurality of images at a plurality of positions (i.e., the image positions 330). Each of the images shows a portion of the rack 102 at a particular position (i.e., a particular image position) of the rack 102. Each portion (i.e., rack portion 332) of the rack 102 can include one or more container positions 334 in which one or more containers 180 are received, respectively. As described herein, the container positions 334 of the rack 102 correspond to the rack slots 190 of the rack 102.

As illustrated in FIG. 20, in some embodiments, the rack 102 has three image positions 330 (such as a first image position 330A, a second image position 330B, and a third image position 330C). In each of the image positions 330, the camera unit 202 is configured to have a field of view (FOV) that captures a portion (i.e., a rack portion) 332 of the rack 102. In the illustrated example, the camera unit 202 can capture an image of a first rack portion 332A when the rack 102 is in the first image position 330A, an image of a second rack portion 332B when the rack 102 is in the second image position 330B, and an image of a third rack portion 332C when the rack 102 is in the third image position 330C. The image of each rack portion 332 can show one or more container positions 334.

In the illustrated example of FIGS. 21A-21C, a first image 350 is captured when the rack 102 is in the first image position 330A. The first image 350 shows the first rack portion 332A of the rack 102 that includes first and second container positions 334A and 334B in the rack 102. A second image 352 is captured when the rack 102 is in the second image position 330B. The second image 352 shows the second rack portion 332B of the rack 102 that includes third and fourth container positions 334C and 334D in the rack 102. A third image 354 is captured when the rack 102 is in the third image position 330C. The third image 354 shows the third rack portion 332C of the rack 102 that includes fifth, sixth, and seventh container positions 334E, 334F, and 334G in the rack 102.

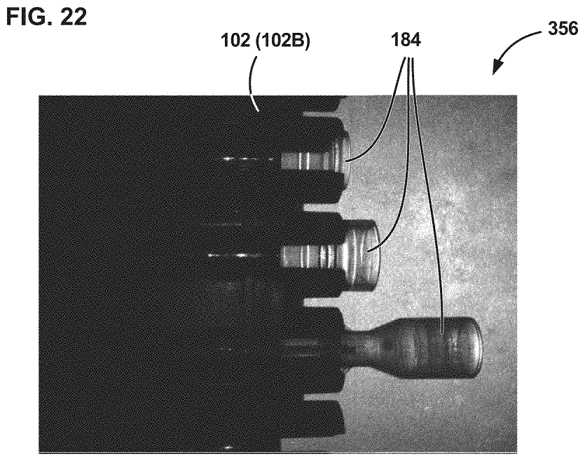

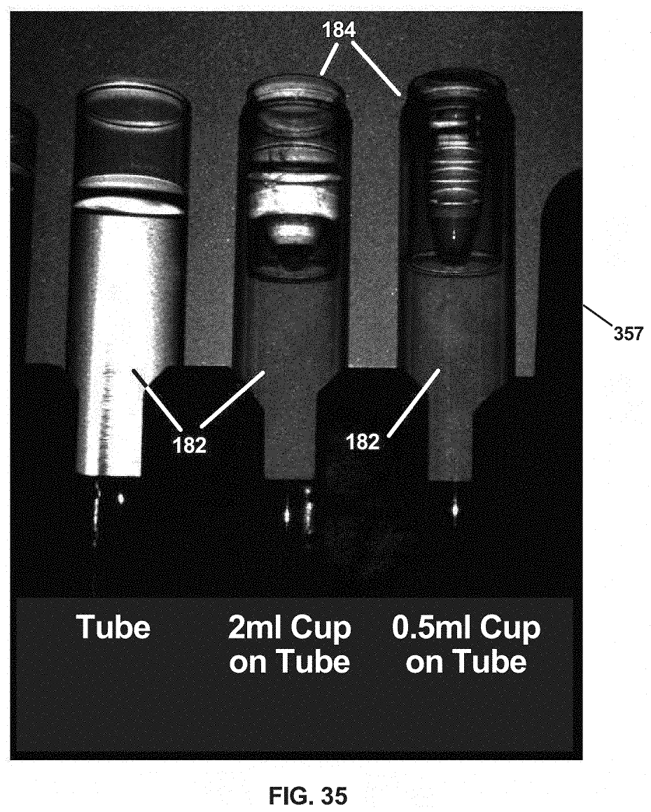

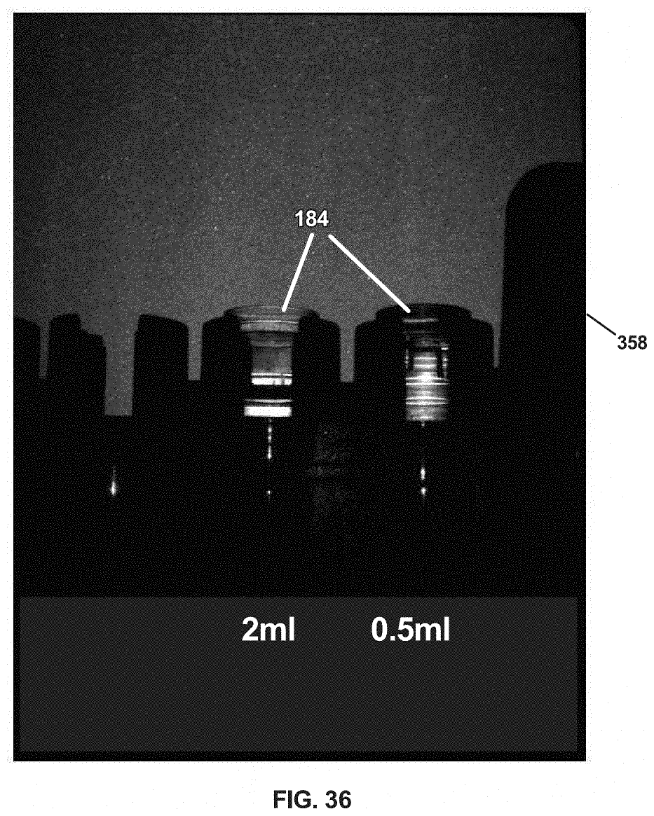

In some embodiments, the images 350, 352, and 354 captured by the camera unit 202 of the sample container recognition unit 110 can be low exposure monochromatic images. The images 350, 352, and 354 illustrated in FIGS. 21A-21C are for the tube rack 102A with sample tubes 182. FIG. 22 illustrates an image 356 of a portion of the cup rack 102B with sample cups 184. FIG. 35 illustrates an image 357 of a portion of a tube rack with three sample tubes 182, two of which have sample cups 184 inserted onto them. FIG. 36 illustrates an image 358 of a portion of a cup rack with sample cups 184.

At operation 304, as the rack 102 is moved toward the first image position 330A, it is detected whether one or more containers 180 are present in a rack portion 332A of the rack 102. As described herein, the container detection unit 204 can operate to perform container presence detection. The rack portion 332A is a portion of the rack 102 that is included in a field of view (FOV) of the camera unit 202 of the sample container recognition unit 110 at or adjacent the first image position 330A. In some embodiments, the container detection unit 204 can operate to detect the container presence in the rack portion (e.g., the first rack portion 332A) of the rack 102 as the rack 102 moves toward the first image position 330A. In other embodiments, the container presence can be detected when the rack 102 is located adjacent or at the first image position 330A.

At operation 306, it is determined whether any container 180 is present in the rack portion 332A of the rack 102. If any container 180 is present (“YES” at this operation), the method 300 moves on to operation 308. If no container 180 is detected (“NO” at this operation), the method 300 moves to operation 316 in which the rack 102 moves to a next image position 330 (e.g., 330B after 330A). As such, if no container is found at a particular image position 330, the rack 102 can bypass that particular image position. For example, the rack 102 can skip to a next image position 330 without performing container recognition operations (such as operations 308 and 310) at the particular image position, thereby saving time and resources.

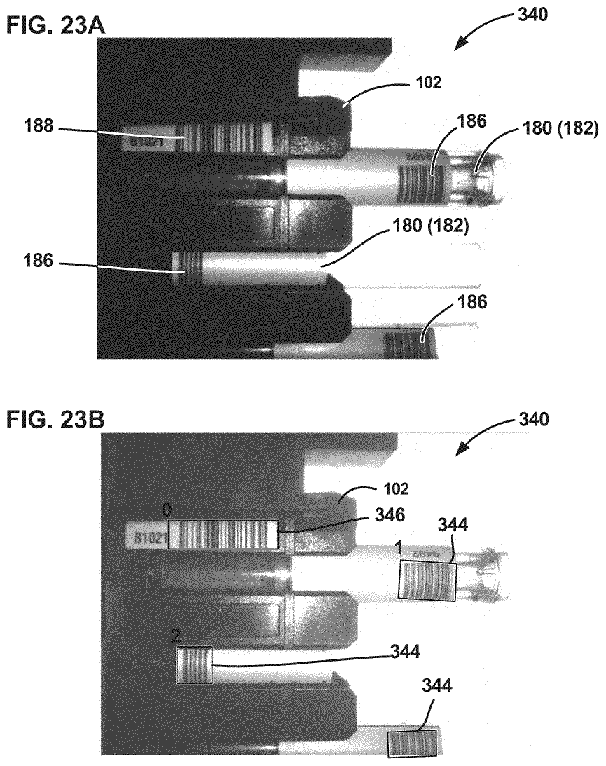

At operation 308, the sample container recognition unit 110 operates to detect one or more container identifiers 186 associated with the containers 180. The sample container recognition unit 110 can further operate to verify the containers 180 based on the detected container identifiers 186. In some embodiments, the rack 102 stops at the image position 330 for the identifier detection. For example, as illustrated in FIG. 23A, the sample container recognition unit 110 (e.g., the camera unit 202 thereof) operates to capture an image 340 of a portion of the rack 102 with the sample tubes 182. In some embodiments, the image 340 is a high exposure monochromatic image for identifier detection. Once the image 340 is captured, the sample container recognition unit 110 operates to identify the container identifiers 186 in the image 340 and read the container identifiers 186 to verify the containers 180 (i.e., the sample tubes 182 in this example). As illustrated with rectangular boxes 344 in FIG. 23B, the container identifiers 186 are identified in the image 340. Various image processing methods can be used to identify and read the container identifiers. One example of such image processing methods is Cognex In-Sight Vision Software, available from Cognex Corporation (Natick, Mass.), which provides various tools, such as edge detection (“Edge”), pattern matching (“Pattern Match”), histogram analysis (“Histogram”), and barcode detection (“ReadIDMax”).

In addition, the sample container recognition unit 110 can operate to detect a rack identifier 188 provided to the rack 102, and verify the rack 102 based on the rack identifier 188. The rack identifier 188 is detected and read in a similar manner to the container identifier 186 as described above. For example, as illustrated in FIG. 23A, the image 340 captured by the sample container recognition unit 110 (e.g., the camera unit 202 thereof) can include a portion of the rack 102 having the rack identifier 188. Once the image 340 is captured, the sample container recognition unit 110 operates to identify the rack identifiers 188 in the image 340 and read the rack identifiers 188 to verify the containers 180. As illustrated with a rectangular box 346 in FIG. 23B, the rack identifier 188 is identified in the image 340. Various image processing methods can be used to identify and read the rack barcode. One example of such image processing methods is Cognex In-Sight Vision Software, available from Cognex Corporation (Natick, Mass.), which provides various tools, such as edge detection (“Edge”), pattern matching (“Pattern Match”), histogram analysis (“Histogram”), and barcode detection (“ReadIDMax”).

At operation 310, the sample container recognition unit 110 operates to determine characteristics of the containers 180. In some embodiments, the rack 102 remains stationary for determining the container characteristics. As described herein, the sample container recognition unit 110 operates to process the images of the rack 102 with containers 180 (such as the images 350, 352, 354, 356, 357 and 358 in FIGS. 21A-21C, 22, 35 and 36), and determine various characteristics associated with the containers 180, such as the dimension (e.g., height and width) of each container and the presence of a cap on the container. Such characteristics can be used to identify the type of the container, as described in more detail below. Various image processing methods can be used to determine such characteristics of the containers in the rack. One example of such image processing methods is Cognex In-Sight Vision Software, available from Cognex Corporation (Natick, Mass.), which provides various tools, such as edge detection (“Edge”), pattern matching (“Pattern Match”), histogram analysis (“Histogram”), and barcode detection (“ReadIDMax”).

At operation 312, it is determined whether the entire rack 102 has been examined. In some embodiments, it is determined whether the rack 102 has moved through all of predetermined image positions 330. In other embodiments, it is determined whether all the rack portions 332 of the rack 102 have been captured by the camera unit 202. In yet other embodiments, it is determined whether all the container positions 334 of the rack 102 have been captured by the camera unit 202.

If it is determined that the entire rack 102 has been examined (“YES” at this operation), the method 300 moves to operation 314 in which the rack 102 is moved to another location within or outside the sample analyzer 100 for subsequent processes (e.g., moved to a new location on the presentation lane 128 where fluids would be aspirated from the sample vessels). Otherwise (“NO” at this operation), the method 300 moves to operation 316 in which the rack 102 moves to a next image position 330 (e.g., 330B after 330A). As the rack 102 moves to the next image position 330 or when the rack 102 is at or adjacent the next image position 330, the operation 304 and the subsequent operations are performed as described above. In some embodiments, when the operation 304 and the subsequent operations are performed, the rack barcode reading (such as illustrated in the operation 308) may be omitted if it has already been done once.

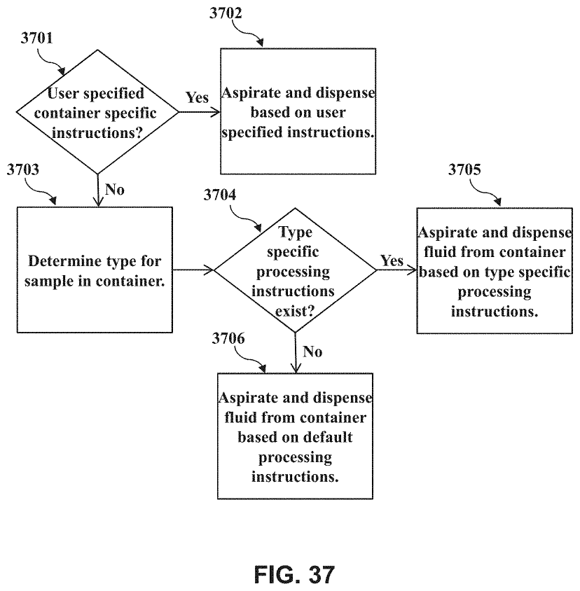

FIG. 37 is a flowchart of an example method for processing a sample in a manner tailored based on identification information such as could have been obtained from a method such as shown in FIG. 19. Initially, in the process of FIG. 37, a determination 3701 is made regarding whether a user had specified instructions for how the contents of a particular container should be processed. This could be done, for example, by the computing device 208 using an identification provided by a barcode affixed to a container, and matching that identification against test orders previously stored in its memory to determine if a specific type of processing (e.g., a specific volume of fluid to aliquot) had been provided by the user for the sample in that container. If there were such user specified container specific instructions, then the fluid from the container could be aspirated and dispensed according to those instructions 3702. For example, if a user had specified that two aliquots, one of volume X and one of volume Y should be taken from a particular sample, the computing device 208 could send instructions to the sample aliquot gantry 105 instructing it to aspirate a first aliquot of volume X and dispense it to a first sample vessel on the sample wheel 129, and to aspirate a second aliquot of volume Y and dispense it to a second sample vessel on the sample wheel 129.

In a process such as depicted in FIG. 37, if no container specific processing instructions had been specified, the process could continue with determining 3703 a type for the sample in the container. This could be done, for example, by using an identifier (e.g., a barcode) identified during a process such as shown in FIG. 19 to retrieve a test order for the sample included in the container, and then treating the sample as having a type based on the ordered test (e.g., if a hepatitis type-B test had been ordered for the sample, then the sample could be determined to have the “hepatitis type-B test” type). Similarly, in some embodiments, the type for a sample could be determined 3703 based on characteristics of the container. For example, if the height and width of the container were consistent with that container being a low volume or pediatric cup, then the “sample could be determined to have the “pediatric” type). As another example of how a type could be determined 3703, in some cases a user may explicitly specify a “type” for a particular sample, in which case the type could be determined 3703 to be the type specified by the user.

After a type had been determined 3703, a check 3704 could be made of whether any type specific instructions exist. This could be done, for example, by a computing device 208 checking a memory to determine if there had been instructions previously set as instructions that should be used to process samples having the determined type. For instance, in the case of an HIV test, it is necessary to confirm a positive result multiple times in order to avoid a mistake and so, to account for this, instructions could be defined in a memory of an analyzer stating that when fluid from a sample having the type “HIV test” is being aspirated from a sample container, a large enough volume should be aspirated to run not only an initial test but also the reflex tests necessary to avoid a mistake. As another example, to account for the low volume of fluid available for samples having the “pediatric” type instructions could be defined stating that fluid from “pediatric” samples should be aspirated using a sample pipettor that could dispense it directly into a reaction vessel in the analyzer's reaction build area, rather than dispensing it into a sample vessel in a sample wheel, thereby avoiding unnecessary loss of effective volume due to dead space in the intermediate sample vessel.

Other, more complicated, approaches to checking 3704 whether specific instructions exist are also possible. To illustrate, consider a case where a sample is determined 3703 to have multiple types, one for a test that would be performed by a first analytic element (e.g., a luminometer in the analyzer) and another that would be performed by a second analytic element (e.g., a flow cell in an external area coupled to the analyzer by a track). In this case, the check 3704 could involve applying a rule that, for samples having types corresponding to tests that would be performed by multiple analytic elements, aliquots should be created for each of the analytic elements that would be used to run a test on the sample. Other variations (e.g., variations where a computing device 208 could determine if there were inconsistent instructions associated with different types and resolve this inconsistency by using a hierarchy of instructions or by providing a warning and requesting further input from a user) are also possible and will be immediately apparent to those of skill in the art in light of this disclosure. Accordingly, the discussion above of checking 3704 for type specific processing instructions should be understood as being illustrative only, and should not be treated as limiting.

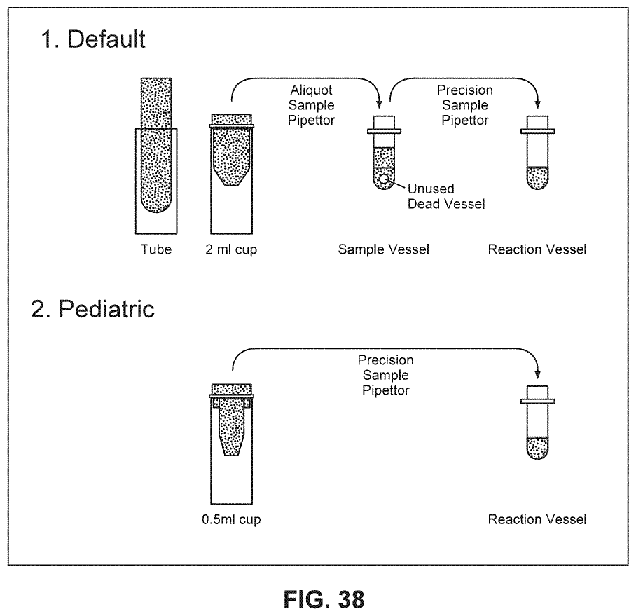

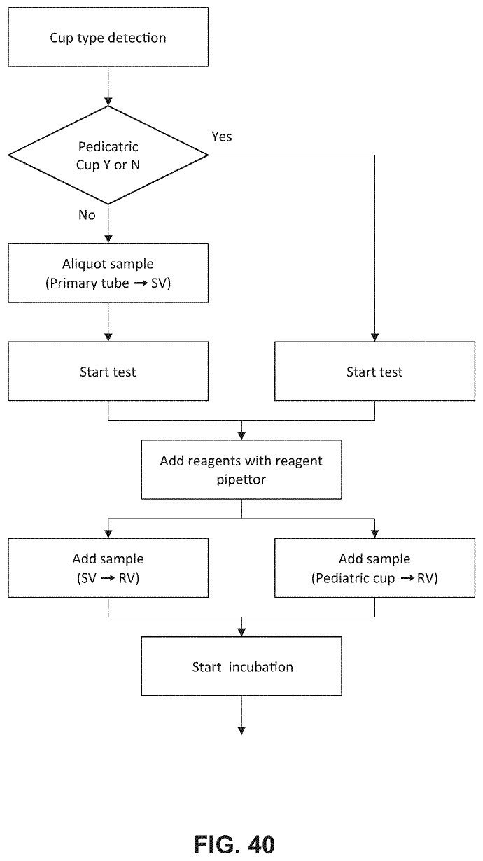

In the process of FIG. 37, if there are type specific instructions for a particular sample, then fluid from that sample's container can be aspirated and dispensed according to those instructions 3705 or, if there are not type specific instructions, then the fluid can be aspirated and dispensed according to the default processing instructions used by the analyzer 3706. For example, in the case of an analyzer with default behavior of aspirating fluid and dispensing it into a sample vessel on a sample wheel for storage until it would subsequently be transferred into a reaction vessel, instructions for a “pediatric” type vessel could be used to cause analyzer to aspirate fluid from the sample container directly into a reaction vessel, as shown in FIG. 38 and FIG. 40. Alternatively, in the absence of such type specific instructions, the sample could simply be processed using the default behavior for the analyzer. The process could then be repeated for each sample container in the rack so that all of the samples would be properly handled by the analyzer.

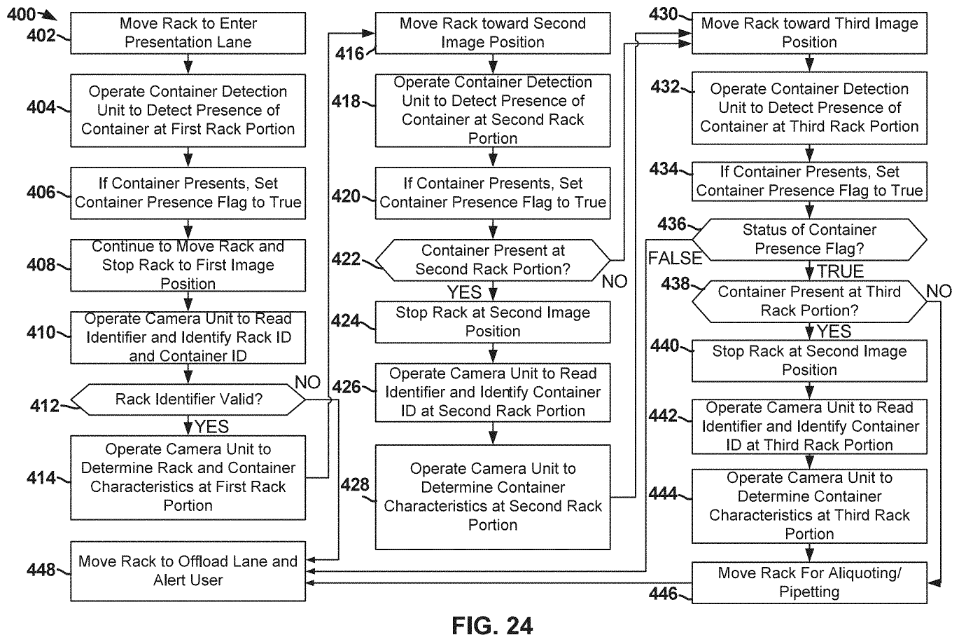

FIG. 24 is a flowchart of another example method 400 for performing sample container recognition with respect to a rack 102. In some embodiments, the method 400 can be at least partially performed by the SPU 104, the sample container recognition unit 110, and/or other devices in the sample analyzer 100.

The method 400 can begin at operation 402 in which the rack 102 is moved to enter the presentation lane 128. In some embodiments, the carrier 132 operates to advance the rack 102 to the presentation lane 128, such as a movement from a position illustrated in FIG. 3 to a position illustrated in FIG. 4.

As illustrated, the rack 102 is oriented to move toward the sample container recognition unit 110 along the presentation lane 128 such that a first rack portion 332A (including first and second container positions 334A and 334B in this example) of the rack 102 first approaches toward the sample container recognition unit 110.

At operation 404, the sample container recognition unit 110 operates the container detection unit 204 to detect presence of any container 180 in the first rack portion 332A of the rack 102. The operation 404 is performed similarly to the operation 304 in FIG. 19. In the illustrated example, the first rack portion 332A of the rack 102 includes a first container position 334A and a second container position 334B, and therefore, the container detection unit 204 operates to detect whether either of the first container position 334A and the second container position 334B is occupied by a container 180, or whether both of the first container position 334A and the second container position 334B are occupied by containers 180, respectively.

As such, the container detection unit 204 performs the first fly-by check on the presence of containers in the first rack portion 332A of the rack 102 as the rack 102 is introduced into the presentation lane 128 and moving toward a first image position 330A, such as illustrated in FIG. 17.

The container detection unit 204 can include one or more sensors of various types. In some examples, the container detection unit 204 includes a photosensor of various types. For example, the container detection unit 204 includes a reflector-type photosensor (also referred to as a reflective photointerrupter or a photoreflector), which positions a light emitting element and a light receiving element on the same surface (so that they face the same direction) and is configured to detect presence and position of an object based on the reflected light from a target object. One example of such a reflector-type photosensor is GP2A25J0000F Series, which is available from Sharp Corporation (Osaka, Japan). Other types of photosensors can also be used for the container detection unit 204.

At operation 406, if any container 180 is detected in the first rack portion 332A of the rack 102, the sample container recognition unit 110 operates to store information representing that the rack includes at least one container therein. For example, the sample container recognition unit 110 operates to set a container presence flag (“At Least One Container Present Flag”) to true if the rack 102 (e.g., the first rack portion 332A thereof) is determined to include one or two containers 180 at the operation 404.

At operation 408, the rack 102 continues to move to the first image position 330A and stops at the first image position 330A. For example, the carrier 132 operates to continuously move the rack 102 to the first image position 330A and stops the rack 102 thereat.

As described herein, the first image position 330A can be a position of the rack 102 relative to the camera unit 202 where the container(s) 180 secured at the first container portion 332A, which include the first and second container positions 334A and 334B, can be at least partially captured by the camera unit 202, as illustrated in FIGS. 21A and 23A. In the illustrated example, the rack identifier 188 provided to the rack 102 is also viewed in the first image position 330A.

At operation 410, the sample container recognition unit 110 operates the camera unit 202 to read a container identifier 186 of each container 180 received in the first rack portion 332A of the rack 102 (which includes the first container position 334A and/or the second container position 334B). The operation 410 is similar to the operation 308 in FIG. 19. In some embodiment, the camera unit 202 operates to capture an image (such as the first image 350 in FIG. 21A) of the first rack portion 332A of the rack 102, and the image is processed to detect and read the container identifiers 186 of the containers 180 at the first and second container positions 334A and 334B (as illustrated in FIGS. 23A and 23B).

Once the container identifiers 186 are read, the sample container recognition unit 110 can identify the containers 180 based on the detected container identifiers 186. The sample container recognition unit 110 can store the identification information of the containers 180 (e.g., container ID(s)).

In some embodiments, the sample container recognition unit 110 operates to compare the detected container identifiers 186 with information provided by the user (e.g., a user input of information about the containers, which can be received through an input device of the sample analyzer 100), and determine if the container identifiers 186 matches the user input. The sample container recognition unit 110 can operate to store information representing that a particular container position 334 (e.g., 334A and/or 334B) includes a container 180 that does not match the user input. For example, the sample container recognition unit 110 can operate to flag the container position 334 of the rack 102 (e.g., the first container position 334A and/or the second container position 334B) that holds the container with the unmatched container identifier 186.

In addition, the sample container recognition unit 110 further operates the camera unit 202 to read the rack identifier 188 of the rack 102. In the illustrated example, the rack identifier 188 is provided adjacent to the first rack portion 332A of the rack 102 (near the first end 164 of the rack 102). Therefore, the image (such as the first image 350 in FIG. 21A) of the first rack portion 332A of the rack 102 includes the rack identifier 188 of the rack 102. The sample container recognition unit 110 processes the image to detect and read the rack identifier 188 of the rack 102.

Once the rack identifier 188 is read, the sample container recognition unit 110 can identify the rack 102 based on the detected rack identifier 188. The sample container recognition unit 110 can store the identification information of the rack 102 (e.g., rack ID).

Various image processing methods can be used to identify and read the identifiers 186 and 188. One example of such image processing methods is Cognex In-Sight Vision Software, available from Cognex Corporation (Natick, Mass.), which provides various tools, such as edge detection (“Edge”), pattern matching (“Pattern Match”), histogram analysis (“Histogram”), and barcode detection (“ReadIDMax”).

At operation 412, the sample container recognition unit 110 can operate to determine whether the rack identifier 188 as detected is valid. If the rack identifier 188 is determined to be valid (“YES” at this operation), the method 400 proceeds to operation 414. Otherwise (“NO” at this operation), the method 400 skips to operation 448 in which the rack 102 is moved to the offload lane 126. At the operation 448, the sample analyzer 100 can operate to alert the user to the invalidity of the rack as determined at the operation 412. The alert can be of various types, such as a visual and/or audible alarm or notification through the sample analyzer 100.

At operation 414, the sample container recognition unit 110 can operate the camera unit 202 to determine characteristics of the container(s) 180 at the first rack portion 332A of the rack 102. The operation 414 is performed similarly to the operation 310 in FIG. 19.

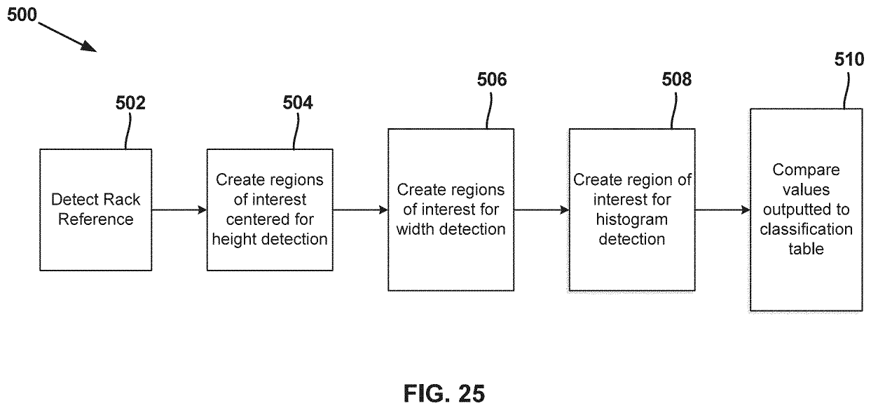

For example, the sample container recognition unit 110 operates to process the image (such as the first image 350 in FIG. 21A) of the first rack portion 332A of the rack 102, and determine various characteristics associated with the containers 180, such as the dimension (e.g., height and width) of each container and the presence of a cap on the container. Such characteristics can be used to identify the type of the container, as described in more detail below. An example detailed method for performing the operation 414 is described and illustrated with reference to FIG. 25.

In addition, the sample container recognition unit 110 can operate the camera unit 202 to determine characteristics of the rack 102, similarly to the determination of the container characteristics. In some embodiments, the image (such as the first image 350 in FIG. 21A) of the first rack portion 332A of the rack 102 can be processed to determine the rack characteristics. In other embodiments, the rack identifier 188 identified from the captured image can be used to determine the rack characteristics.

In some embodiments, the data of the container characteristics and/or the rack characteristics obtained above can be stored in the sample container recognition unit 110. In some embodiments, if the container(s) have predetermined undesirable characteristics (e.g., uncapped, unapproved, and/or inappropriate container positions), the sample container recognition unit 110 can store information representing that a particular container position 334 (e.g., 334A and/or 334B) includes a container 180 that does not match the user input. For example, the sample container recognition unit 110 can operate to flag the container position 334 of the rack 102 (e.g., the first container position 334A and/or the second container position 334B) that holds the container with such undesirable characteristics.

At operation 416, the rack 102 is operated to move toward the second image position 330B. As described herein, the second image position 330B can be a position of the rack 102 relative to the camera unit 202 where the container(s) 180 secured at the second container portion 332B, which include the third and fourth container positions 334C and 334D, can be at least partially captured by the camera unit 202, as illustrated in FIG. 21B.

At operation 418, the sample container recognition unit 110 operates the container detection unit 204 to detect presence of any container 180 in the second rack portion 332B of the rack 102. The operation 418 is performed similarly to the operation 304 in FIG. 19, or the operation 404 above. In the illustrated example, the second rack portion 332B of the rack 102 includes the third container position 334C and the fourth container position 334D, and therefore, the container detection unit 204 operates to detect whether either of the third container position 334C and the fourth container position 334D is occupied by a container 180, or whether both of the third container position 334C and the fourth container position 334D are occupied by containers 180, respectively.

As such, the container detection unit 204 performs the second fly-by check on the presence of containers in the second rack portion 332B of the rack 102 as the rack 102 is moving toward the second image position 330B.

At operation 420, if any container 180 is detected in the second rack portion 332B of the rack 102, the sample container recognition unit 110 operates to store information representing that the rack includes at least one container therein. For example, the sample container recognition unit 110 operates to set the container presence flag (“At Least One Container Present Flag”) to true if the rack 102 (e.g., the second rack portion 332B thereof) is determined to include one or two containers 180 at the operation 418.

At operation 422, it is determined whether any container is present at the second rack portion 332B of the rack 102 (e.g., either or both of the third container position 334C and the fourth container position 334D). If the presence of any container is determined at the second rack portion 332B (“YES”), the method 400 continues to operation 424. Otherwise (“NO”), the method 400 skips to operation 448.

At operation 424, the rack 102 is stopped and made stationary at the second image position 330B.

At operation 426, the sample container recognition unit 110 operates the camera unit 202 to read a container identifier 186 of each container 180 received in the second rack portion 332B of the rack 102 (which includes the third container position 334A and/or the fourth container position 334D). The operation 418 is similar to the operation 308 in FIG. 19, or the operation 410 above. In some embodiment, the camera unit 202 operates to capture an image (such as the second image 352 in FIG. 21B) of the second rack portion 332B of the rack 102, and the image is processed to detect and read the container identifiers 186 of the containers 180 at the third and fourth container positions 334C and 334D.

Once the container identifiers 186 are read, the sample container recognition unit 110 can identify the containers 180 based on the detected container identifiers 186. The sample container recognition unit 110 can store the identification information of the containers 180 (e.g., container ID(s)).

In some embodiments, the sample container recognition unit 110 operates to compare the detected container identifiers 186 with information provided by the user (e.g., a user input of information about the containers, which can be received through an input device of the sample analyzer 100), and determine if the container identifiers 186 matches the user input. The sample container recognition unit 110 can operate to store information representing that a particular container position 334 (e.g., 334C and/or 334D) includes a container 180 that does not match the user input. For example, the sample container recognition unit 110 can operate to flag the container position 334 of the rack 102 (e.g., the first container position 334C and/or the second container position 334D) that holds the container with the unmatched container identifier 186.

In some embodiments, the sample container recognition unit 110 further operates to cross check if the containers 180 identified at the second image position 330B match (or be compatible with) the identification of the rack 102 (e.g., the rack ID found at the operation 410).

At operation 428, the sample container recognition unit 110 can operate the camera unit 202 to determine characteristics of the container(s) 180 at the second rack portion 332B of the rack 102. The operation 414 is performed similarly to the operation 310 in FIG. 19 or the operation 414 above.

For example, the sample container recognition unit 110 operates to process the image (such as the second image 352 in FIG. 21B) of the second rack portion 332B of the rack 102, and determine various characteristics associated with the containers 180, such as the dimension (e.g., height and width) of each container and the presence of a cap on the container. Such characteristics can be used to identify the type of the container, as described in more detail below. An example detailed method for performing the operation 428 is described and illustrated with reference to FIG. 25.

In some embodiments, the data of the container characteristics obtained above can be stored in the sample container recognition unit 110. In some embodiments, if the container(s) have predetermined undesirable characteristics (e.g., uncapped, unapproved, and/or inappropriate container positions), the sample container recognition unit 110 can store information representing that a particular container position 334 (e.g., 334C and/or 334D) includes a container 180 that does not match the user input. For example, the sample container recognition unit 110 can operate to flag the container position 334 of the rack 102 (e.g., the third container position 334C and/or the fourth container position 334D) that holds the container with such undesirable characteristics.

At operation 430, the rack 102 is operated to move toward the third image position 330C. As described herein, the third image position 330C can be a position of the rack 102 relative to the camera unit 202 where the container(s) 180 secured at the third container portion 332C, which include the fifth, sixth, and seventh container positions 334E, 334F, and 334G, can be at least partially captured by the camera unit 202, as illustrated in FIG. 21C.

At operation 432, the sample container recognition unit 110 operates the container detection unit 204 to detect presence of any container 180 in the third rack portion 332C of the rack 102. The operation 432 is performed similarly to the operation 304 in FIG. 19, or the operation 404 or 418 above. In the illustrated example, the third rack portion 332C of the rack 102 includes the fifth container position 334E, the sixth container position 334F, and the seventh container position 334G, and therefore, the container detection unit 204 operates to detect whether any or all of the fifth container position 334E, the sixth container position 334F, and the seventh container position 334G are occupied by a container or containers 180.

As such, the container detection unit 204 performs the third fly-by check on the presence of containers in the third rack portion 332C of the rack 102 as the rack 102 is moving toward the third image position 330C.

At operation 434, if any container 180 is detected in the third rack portion 332C of the rack 102, the sample container recognition unit 110 operates to store information representing that the rack includes at least one container therein. For example, the sample container recognition unit 110 operates to set the container presence flag (“At Least One Container Present Flag”) to true if the rack 102 (e.g., the third rack portion 332B thereof) is determined to include one or two containers 180 at the operation 432.

At operation 436, the sample container recognition unit 110 operates to determine the status (either true or false) of the container presence flag (“At Least One Container Present Flag”). If the status is true (“True”), the method 400 goes on to operation 438. Otherwise (“False”), the method 400 skips to operation 448.

At operation 438, it is determined whether any container is present at the third rack portion 332C of the rack 102 (e.g., any or all of the fifth container position 334E, the sixth container position 334F, and the seventh container position 334G). If the presence of any container is determined at the third rack portion 332C (“YES”), the method 400 continues to operation 440. Otherwise (“NO”), the method 400 skips to operation 446.

At operation 440, the rack 102 is stopped and made stationary at the third image position 330C.

At operation 442, the sample container recognition unit 110 operates the camera unit 202 to read a container identifier 186 of each container 180 received in the third rack portion 332C of the rack 102 (which includes the fifth container position 334E, the sixth container position 334F, and the seventh container position 334G). The operation 418 is similar to the operation 308 in FIG. 19, or the operation 410 or 426 above. In some embodiment, the camera unit 202 operates to capture an image (such as the third image 354 in FIG. 21C) of the third rack portion 332C of the rack 102, and the image is processed to detect and read the container identifiers 186 of the containers 180 at the fifth container position 334E, the sixth container position 334F, and the seventh container position 334G.

Once the container identifiers 186 are read, the sample container recognition unit 110 can identify the containers 180 based on the detected container identifiers 186. The sample container recognition unit 110 can store identification information of the samples in the containers 180 (e.g., Sample ID(s), representing a patient ID connected to test order requested by a physician for the sample).

In some embodiments, the sample container recognition unit 110 operates to compare the detected container identifiers 186 with information provided by the user (e.g., a user input of information about the containers, which can be received through an input device of the sample analyzer 100), and determine if the container identifiers 186 matches the user input. The sample container recognition unit 110 can operate to store information representing that a particular container position 334 (e.g., 334E, 334F, and/or 334G) includes a container 180 that does not match the user input. For example, the sample container recognition unit 110 can operate to flag the container position 334 of the rack 102 (e.g., the fifth container position 334E, the sixth container position 334F, and/or the seventh container position 334G) that holds the container with the unmatched container identifier 186.

In some embodiments, the sample container recognition unit 110 further operates to cross check if the containers 180 identified at the third image position 330C match (or be compatible with) the identification of the rack 102 (e.g., the rack ID found at the operation 410).

At operation 444, the sample container recognition unit 110 can operate the camera unit 202 to determine characteristics of the container(s) 180 at the third rack portion 332C of the rack 102. The operation 414 is performed similarly to the operation 310 in FIG. 19 or the operation 414 or 428 above.

For example, the sample container recognition unit 110 operates to process the image (such as the third image 354 in FIG. 21C) of the third rack portion 332C of the rack 102, and determine various characteristics associated with the containers 180, such as the dimension (e.g., height and width) of each container and the presence of a cap on the container. Such characteristics can be used to identify the type of the container, as described in more detail below. An example detailed method for performing the operation 444 is described and illustrated with reference to FIG. 25.

In some embodiments, the data of the container characteristics obtained above can be stored in the sample container recognition unit 110. In some embodiments, if the container(s) have predetermined undesirable characteristics (e.g., uncapped, unapproved, and/or inappropriate container positions), the sample container recognition unit 110 can store information representing that a particular container position 334 (e.g., 334E, 334F, and/or 334G) includes a container 180 that does not match the user input. For example, the sample container recognition unit 110 can operate to flag the container position 334 of the rack 102 (e.g., the fifth container position 334E, the sixth container position 334F, and/or the seventh container position 334G) that holds the container with such undesirable characteristics.

At operation 446, the rack 102 is moved to an aliquoting and/or pipetting system for sample processing.

In some embodiments, the information outputted to the aliquoting and/or pipetting system from the SPU with the sample container recognition unit 110 includes information about the barcodes, which can be used to prioritize sample aspiration and indicate types of sample (e.g., low volume, STAT, and calibration samples). The information from the SPU with the sample container recognition unit 110 can further include vision information, such as types of containers, which can be determined from a library of container types. The information that can be provided to the sample pipettor may include a starting position to start level sensing to detect liquid (top of container), a maximum allowable depth of travel during aspiration (liquid dead volume or bottom of container), and an internal geometry of sample container (useful for accurate aspiration in cause any further offsets required of the SPU and the pipettor). The information can also include type or sample specific instructions for the aliquoting and/or pipetting system (e.g., pipettor gantries 105 107) to process the samples in a manner such as described previously in the context of FIG. 37.

At operation 448, once the sample processing is performed at the operation 446, the rack 102 is moved to the offload lane 126. Further, the sample analyzer 100 can operate to alert the user to various pieces of information, such as the invalidity of the rack as determined at the operation 412, the status (i.e., false) of the container presence flag as determined at the operation 436, or the end of the sample processing as performed at the operation 446. The alert can be of various types, such as a visual and/or audible alarm or notification through the sample analyzer 100.

As described above, if no container is found at a particular image position 330, the rack 102 can bypass that particular image position. For example, the rack 102 can skip to a next image position 330 without performing container recognition operations at the particular image position. As such, the bypass algorithm around the vision checks can save time. The main instrument has a cycle time (e.g., 8 seconds), and the SPU operation is partially independent of the main instrument, but ideally finishes within 8 seconds. For example, if a number improper racks are present, then bypassing allows them to be cleared quickly. Therefore, thanks to the bypassing, the main instrument does not need to wait for the SPU to complete its operation.

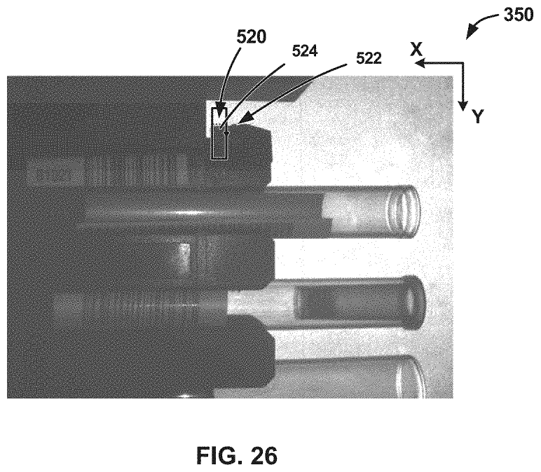

FIG. 25 is a flowchart of an example method 500 for processing an image of a rack with one or more containers and determining characteristics of the containers therein. In some embodiments, the method 500 is used to perform the operations 414, 428, and 444 as described in FIG. 24. In some embodiments, the method 500 can be at least partially performed by the SPU 104, the sample container recognition unit 110, and/or other devices in the sample analyzer 100. The method 300 is described with reference also with FIGS. 26-32.

The method 500 can begin at operation 502 in which a rack reference 520 is identified in a captured image. In some embodiments, the first hook 160 (also referred to herein as a front tab) of the rack 102 is used as the rack reference 520. The first hook 160 can be detected in an image (e.g., the first image 350) captured when the rack 102 is at a first stopping position (e.g., the first image position 330A).

For example, an edge 522 of the rack 102 (FIG. 5) is predetermined as the rack reference 520. The predetermined edge 522 of the rack 102 can be recognized in the first image 350 by the sample container recognition unit 110, as illustrated in FIG. 26. In this illustration, the identified edge 522 of the rack 102 is indicated as a line 524, which is an icon representative of the recognition by the camera unit 202 of the edge 522. In this embodiment, the X-axis assumes that the rack 102 is fully engaged.

At operation 504, the sample container recognition unit 110 operates to create one or more regions of interest 528 (also referred to herein as height regions of interest) for container height detection. In some embodiments, three regions of interest 528 (including 528A, 528B, and 528C) are created relative to the rack reference 520, such as by offsetting from the rack reference 520 in the Y-axis.

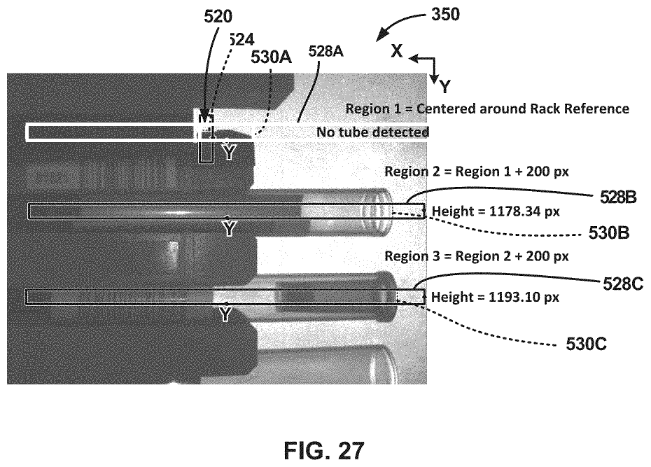

In the illustrated example of FIG. 27, in the image 350, a first region of interest 528A is created and arranged to be centered on the rack reference 520 in the Y-axis. A second region of interest 528B is created and arranged to be offset from the first region of interest 528A at a predetermined distance (e.g., 200 pixels in FIG. 27) in the Y-axis. A third region of interest 528C is created and arranged to be offset from the second region of interest 528B at a predetermined distance (e.g., 200 pixels in FIG. 27) in the Y-axis. Alternatively, the third region of interest 528C can be created by offsetting from the first region of interest 528A.

For each of the regions of interest 528, the sample container recognition unit 110 operates to detect a top tube edge 530 (e.g., 530A, 530B, and 530C) and determine the height of the associated container 180. In the illustrated example of FIG. 27, the height of the container 180 associated with the second region of interest 528B is measured to be 1178.34 pixels, and the height of the container 180 associated with the third region of interest 528C is measured to be 1193.10 pixels.

In some embodiments, a result indicating that no container has been detected can be generated, instead of reporting the height of the container. For example, there is no container in the first region of interest 528A, and thus, the no-container-detection result will be outputted. In other embodiments, the sample container recognition unit 110 operates to determine the X-coordinate measurement of the rack using the top tube edge 530A in the first region of interest 528A.

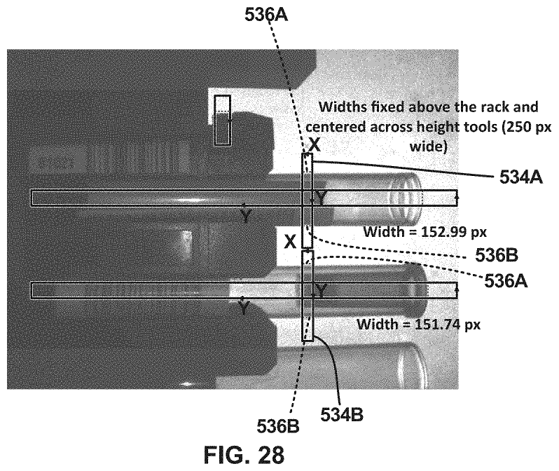

At operation 506, the sample container recognition unit 110 operates to create one or more regions of interest 534 (also referred to herein as width regions of interest) for container width (or diameter) detection. In some embodiments, the width regions of interest 534 are created at a preset distance above the rack 102 (in the X-axis) and centered across the height regions of interest 528, respectively. The width regions of interest 534 are arranged to transverse the height regions of interest 528, respectively. In some embodiments, the width (i.e., the Y-axis distance) of each width region of interest 534 can be preset, such as 250-pixel wide in FIG. 28.

For each of the width regions of interest 534, the sample container recognition unit 110 operates to detect two opposite sides 536A and 536B of the container and determine the width of the associated container 180. In the illustrated example of FIG. 28, the width of the container 180 associated with a region of interest 534A is measured to be 152.99 pixels (i.e., a pixel distance between the opposite sides 536A and 536B), and the width of the container 180 associated with a region of interest 534B is measured to be 151.74 pixels (i.e., a pixel distance between the opposite sides 536A and 536B).

At operation 508, the sample container recognition unit 110 operates to create one or more regions of interest 540 (also referred to herein as histogram regions of interest) for histogram analysis.

In some embodiments, three histogram regions of interest 540 (including 540A, 540B, and 540C) created relative to the top of each height region, such as by offsetting from the top tube edge 530 in the X-axis. In some embodiments, the histogram regions of interest 540 are created at a preset distance from the top tube edge 530 in the X-axis (e.g., 5 pixels from the top tube edge 530), while detection of the container has occurred. In some embodiments, the dimension of each histogram region of interest 540 can be predetermined.

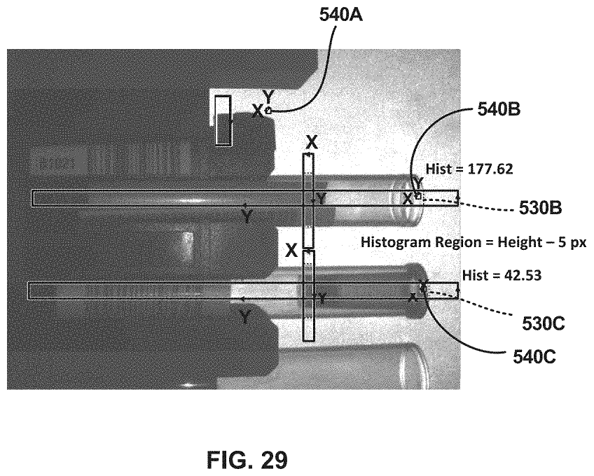

Once the histogram regions of interest 540 are created, a histogram value is obtained for each of the histogram regions of interest 540. In the illustrated example of FIG. 29, the histogram value of a region of interest 540B associated with the second region of interest 528B is measured to be 177.62, and the histogram value of a region of interest 540C associated with the third region of interest 528C is measured to be 42.53.

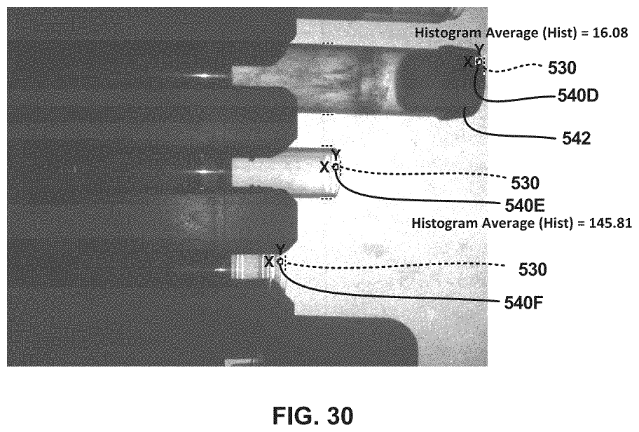

In some embodiments, the histogram analysis at the operation 508 can also detect presence of a cap on the container. As illustrated in FIG. 30, the measurement of histogram regions of interest 540 can indicate whether a cap is present or not. In some embodiments, a low histogram value can indicate that a cap is present in that position, and a high histogram value can indicate no cap is present at that position. In the example of FIG. 30, the average histogram value of a region of interest 540D over a cap 542 of the container 180 is measured to be 16.08 (a relatively low value), and the average histogram value of regions of interest 540E and 540F over the containers 180 without a cap are measured to be 145.81.

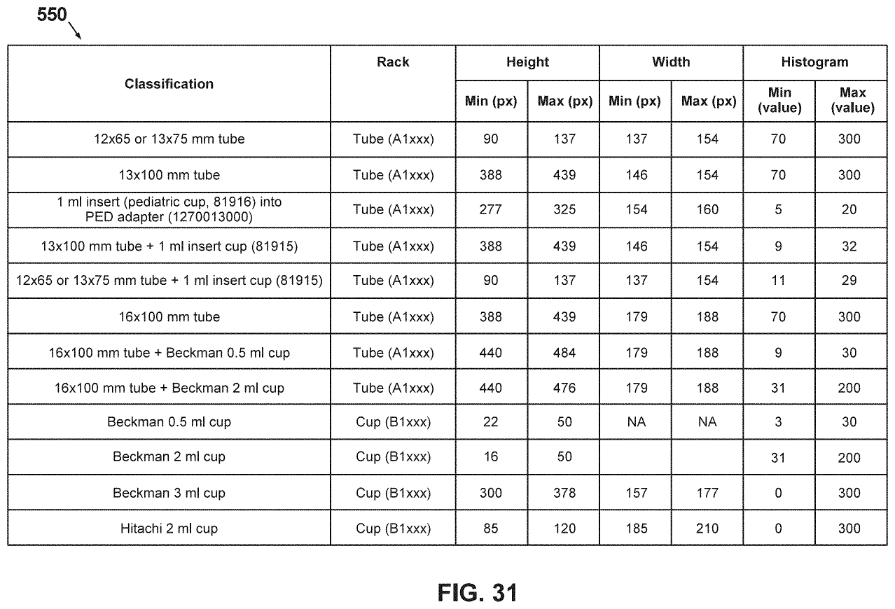

At operation 510, the sample container recognition unit 110 operates to compare the information obtained at the operations above with a classification table 550 (FIG. 31). For example, for each container, the height value, the width value, and/or the histogram value, can be compared with values in the classification table 550, and a type of the container is determined based on the comparison.

As illustrated in FIG. 31, the classification table 550 is provided to classify different types of containers (the first column) based on the height, width, and histogram values. For each type of container, the height, width, and histogram values can be provided with a minimum value, a maximum value, and an average value. By way of example, if the height value obtained in the method 500 is between 90 and 137, the width value obtained in the method 500 is between 137 and 154, and the histogram value obtained in the method 500 is between 70 and 300, the container at issue can be identified as 12×65 or 13×75 mm tube with a cap (the second row of the table 550).

Alternatively, in some embodiments less than all information shown in a table such as illustrated in FIG. 31 could be used in identifying types of containers. For example, in some embodiments containers could be classified as low volume (e.g., pediatric containers) or non-low volume based solely on height and histogram data, rather than also relying on width. In such an embodiment, a container could be considered to be low volume if it had a height of between 16 and 50 and a histogram value of between 0 and 30, while containers with greater height or histogram values could be treated as non-low volume. Additionally, in some embodiments, information such as discussed above could be used to determine if there had been an error in container classification. For example, if height and histogram information did not match (e.g., height consistent with a low volume container, and histogram consistent with a non-low volume container) this could be recognized as an error that should be brought to the attention of a user so he or she could manually specify the correct type for the container. Similarly, in some embodiments there may be gaps in information used to classify various types of containers (e.g., a height between 16 and 50 would be treated as a low volume container, while a height greater than 85 would be treated as a high volume containers) which could similarly be used to identify errors for remediation (e.g., if a measurement fell into a gap). Accordingly, the discussion of container type classification set forth above should be understood as being illustrative only, and should not be treated as limiting.

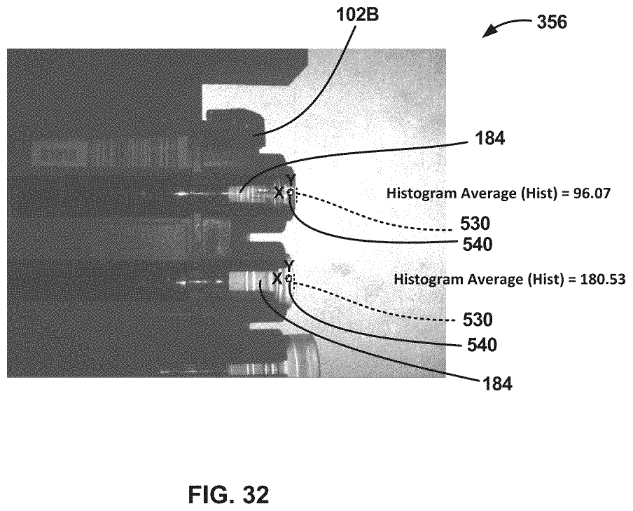

As illustrated in FIG. 32, where the rack 102 is a cup rack 102B with sample cups 184, the same method 500 can be applied to identify the type of the sample cups 184. As described above, the measurement of histogram regions of interest 540 indicates which types of the cups are present. The histogram data may be combined with other measurements such as height and width (diameter) to determine the types of the cups in the cup rack 102B.

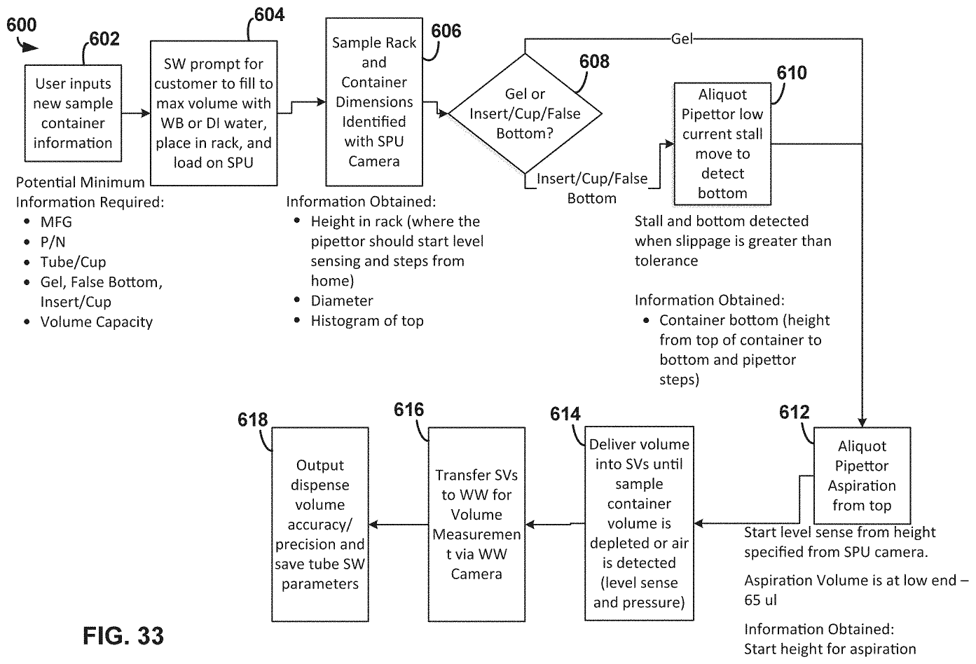

FIG. 33 is a flowchart of an example method 600 for adding and verifying a new container in the classification table 550 (i.e., container library, list of approved containers, etc.).

At step 602, the user enters information on a new sample container. This information may include type of container, internal geometry, volume, manufacturer part number, external dimensions, etc. At step 604, the user loads rack with container of interest to be added to the classification table 550 by software (i.e., SW). The user further fills up the container to maximum volume, and loads the rack 102 into the onload lane 124 of the SPU 104.

When the user inputs new sample container information (at operation 602), the sample analyzer 100 (e.g., a software application herein) operates to prompt for the user to provide the maximum volume with wash buffer or deionized water, places the new sample container in the rack 102, and loads it on the SPU 104 (at operation 604). At the operation 602, the information may include information about a manufacturer, a part number, a type of container (e.g., either a tube or a cup), plasma or serum gel matrix in tube) internal container geometry, insert/cup, (i.e., a cup sitting inside of a tube), and/or a volume capacity.

Then, at operation 606, the SPU (including the sample container recognition unit 110 therein) operates to identify the dimensions of the sample rack and containers therein. In some embodiments, the information obtained includes a height in the rack (e.g., where the pipettor should start level sensing and steps from a home position), a diameter, and a histogram value at the top of each container.

At operation 608, it is determined whether the new sample container is a gel or insert/cup, etc. If operation 608 determines container to be an insert/cup/, etc. then the aliquot pipettor moves to detect the bottom of the container at operation 610. If operation 608 determines the container to be a gel tube, then the aliquot pipettor begins aliquoting from near the top of the liquid in the container.

At steps 608-618, the sample analyzer 100 (i.e., the instrument) processes the new container and observes the characteristics of the new container as measured by the various detection functions of the sample analyzer 100. For example, to measure volume at step 616, all the fluid from the container is transferred to a sample vessel (i.e., SV), and the sample vessel is transferred to the wash wheel (i.e., WW).

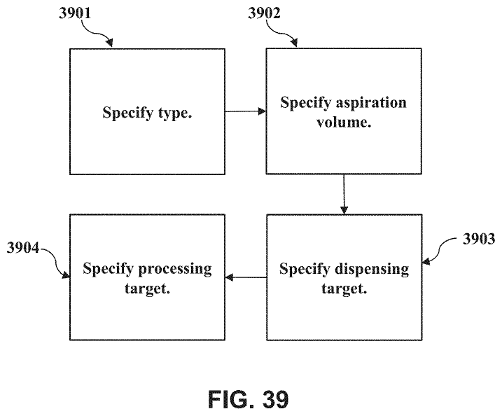

Just as, in some embodiments, a user could be allowed to add new containers to a container library using a process such as shown in FIG. 33, in some embodiments a user could be allowed to add new type-specific instructions that could be used in a process such as shown in FIG. 37. An example of a process that could be used to add such type-specific instructions is provided in FIG. 39.

In a process such as shown in FIG. 39, a user adding type specific instructions may initially specify 3901 the type for which the instructions are being provided. This could be done, for example, by a computing device 208 retrieving information from its memory indicating what types could potentially be encountered on an analyzer (e.g., what types of tests the analyzer was capable of performing, what types of containers were included in a library, etc.) and then presenting an interface with one or more dropdown menus for those types (e.g., one drop down menu for container types, one drop down menu for test types, etc.) from which the user would specify the type for which he or she was adding instructions. Similarly, in some embodiments where type specific instruction specification is supported, a user may be given the option of entering information into fields corresponding to data that the analyzer would be provided for individual samples (e.g., tests to be performed, etc.), and then when a sample was being processed, the information for that sample could be compared against the information added by the user to determine the sample's type. Other approaches (e.g., combinations where a user could be allowed to select from prespecified type menus or enter types as free text) are also possible and will be immediately apparent to those of ordinary skill in the art in light of this disclosure.

After a type has been specified 3901 various processing parameters for that type could be added as well. For example, a user could specify 3902 an aspiration volume—i.e., the amount of fluid to be aspirated from a sample container for a sample having the specified type. Similarly, in some embodiments a user may specify 3903 a dispensing target—e.g., a sample wheel (for types which should initially be added to a sample vessel before being transferred to a separate reaction vessel) or a reaction build area (for types that should be dispensed directly into a reaction vessel without being dispensed into an intermediate sample vessel first). Some embodiments may also allow a user to specify 3904 a processing target, such as that a particular type of test should be performed using a piece of equipment external, but connected to, the analyzer.

FIG. 34 illustrates an exemplary architecture of a computing device that can be used to implement aspects of the present disclosure, including the sample analyzer 100 or various systems of the sample analyzer 100, such as the sample container recognition unit 110 and other subunits or subdevices. Further, one or more devices or units included in the systems of the sample analyzer 100 can also be implemented with at least some components of the computing device as illustrated in FIG. 34. Such a computing device is designated herein as reference numeral 700. The computing device 700 is used to execute the operating system, application programs, and software modules (including the software engines) described herein.

The computing device 700 includes, in some embodiments, at least one processing device 702, such as a central processing unit (CPU). A variety of processing devices are available from a variety of manufacturers, for example, Intel or Advanced Micro Devices. In this example, the computing device 700 also includes a system memory 704, and a system bus 706 that couples various system components including the system memory 704 to the processing device 702. The system bus 706 is one of any number of types of bus structures including a memory bus, or memory controller; a peripheral bus; and a local bus using any of a variety of bus architectures.

Examples of computing devices suitable for the computing device 700 include a desktop computer, a laptop computer, a tablet computer, a mobile device (such as a smart phone, an iPod® mobile digital device, or other mobile devices), or other devices configured to process digital instructions.

The system memory 704 includes read only memory 708 and random access memory 710. A basic input/output system 712 containing the basic routines that act to transfer information within computing device 700, such as during start up, is typically stored in the read only memory 708.

The computing device 700 also includes a secondary storage device 714 in some embodiments, such as a hard disk drive, for storing digital data. The secondary storage device 714 is connected to the system bus 706 by a secondary storage interface 716. The secondary storage devices and their associated computer readable media provide nonvolatile storage of computer readable instructions (including application programs and program modules), data structures, and other data for the computing device 700.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 714 or memory 704, including an operating system 718, one or more application programs 720, other program modules 722, and program data 724.

In some embodiments, computing device 700 includes input devices to enable a user to provide inputs to the computing device 700. Examples of input devices 726 include a keyboard 728, pointer input device 730, microphone 732, and touch sensitive display 740. Other embodiments include other input devices 726. The input devices are often connected to the processing device 702 through an input/output interface 738 that is coupled to the system bus 706. These input devices 726 can be connected by any number of input/output interfaces, such as a parallel port, serial port, game port, or a universal serial bus. Wireless communication between input devices and interface 738 is possible as well, and includes infrared, BLUETOOTH® wireless technology, WiFi technology (802.11 a/b/g/n etc.), cellular, and/or other radio frequency communication systems in some possible embodiments.

In this example embodiment, a touch sensitive display device 740 is also connected to the system bus 706 via an interface, such as a video adapter 742. The touch sensitive display device 740 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

In addition to the display device 740, the computing device 700 can include various other peripheral devices (not shown), such as speakers or a printer.

The computing device 700 further includes a communication device 746 configured to establish communication across the network. In some embodiments, when used in a local area networking environment or a wide area networking environment (such as the Internet), the computing device 700 is typically connected to the network through a network interface, such as a wireless network interface 748. Other possible embodiments use other wired and/or wireless communication devices. For example, some embodiments of the computing device 700 include an Ethernet network interface, or a modem for communicating across the network. In yet other embodiments, the communication device 746 is capable of short-range wireless communication. Short-range wireless communication is one-way or two-way short-range to medium-range wireless communication. Short-range wireless communication can be established according to various technologies and protocols. Examples of short-range wireless communication include a radio frequency identification (RFID), a near field communication (NFC), a Bluetooth technology, and a Wi-Fi technology.

The computing device 700 typically includes at least some form of computer-readable media. Computer readable media includes any available media that can be accessed by the computing device 700. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 700.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The various embodiments described above are provided by way of illustration only and numerous modifications and combinations of the described embodiments will be immediately apparent to, and could be implemented without undue experimentation by, those of ordinary skill in the art in light of this disclosure. For example, while the processes of FIGS. 19 and 24 included steps of detecting identifiers for racks and/or containers to use in subsequent processing, some embodiments my omit this type of detection, or may detect identifiers as indicated but omit their use in subsequent processing. For instance, in embodiments that implement functionality to dispense fluid aspirated from pediatric samples directly into reaction vessels rather than first dispensing the fluid into an intermediate sample vessel, this fluid handling might be made purely on the basis of detecting that the fluid was in a pediatric cup, and may not make use of identifiers on either container itself or its rack. Indeed, in some embodiments, type specific processing functionality may be provided entirely independently of any type of machine vision or image processing. For example, a type for a sample could be determined based on its position in a rack using the assumption that the correct samples were loaded into the correct positions. As another illustration, in some cases techniques such as described herein for identifying sample containers based on their shape could potentially be used in laboratory automation to determine machines to which a particular container should be routed (e.g., an identification of a container as being a low volume or pediatric container may result in that container being routed directly to a diagnostic instrument rather than sending it to a separate aliquoter). Accordingly, in light of the potential for such variations and combinations, the protection provided by this document or any related document should not be limited to the material explicitly disclosed herein, but should instead be defined by such document's claims when those claims are interpreted according to their broadest reasonable interpretation and any explicit definitions provided for their terms.

1. An automated clinical analyzer comprising:
a) a sample presentation unit (104) comprising a sample presentation lane (128); and b) a computing device (208) configured to perform one or more acts selected from a set consisting of:
i) identify a type for a sample container (180) in the sample presentation lane (128) based on an image of that sample container (180) captured by a camera (202), and, based on the type, differentiate downstream processing for fluid contained in the sample container (180); and
ii) based on identification information for the sample container (180) in the sample presentation lane (128), determine a target location and transfer fluid from the sample container (180) in the sample presentation lane (128) to the target location.

2-18. (canceled)

19. A method of operating an automated clinical analyzer, the method comprising: a) presenting a sample container (180) in a sample presentation lane (128) of a sample presentation unit (104);
b) a computing device (208) performing one or more acts selected from a set consisting of:
i) identifying a type for the sample container (180) in the sample presentation lane (128) based on an image of that sample container (180) captured by a camera (202) and, based on the type, differentiating downstream processing for fluid contained in the sample container (180); and
ii) based on identification information for the sample container (180) in the sample presentation lane (128), determining a target location and transferring fluid from the sample container (180) in the sample presentation lane (128) to the target location.

20. The method of claim 19, wherein:
a) the clinical analyzer comprises a set of one or more gantries (106), wherein each gantry from the set of one or more gantries (106):
i) is disposed at an angle relative to the sample presentation lane (128) of the sample presentation unit (104);
ii) is configured to translate a corresponding pipettor along its length and to cause the corresponding pipettor to aspirate or dispense fluids based on commands from the computing device (208); and iii) has a portion disposed above the sample presentation lane (128) of the sample presentation unit (104);
and
b) the computing device (208) is configured to, based on identification information for the sample container (180) in the sample presentation lane (128):
i) determine a first amount of fluid; and
ii) determine the target location and transfer fluid from the sample container (180) in the sample presentation lane (180) to the target location;
c) the computing device (208) is configured to transfer fluid from the sample container (180) in the sample presentation lane (180) to the target location by sending commands to a gantry from the set of one or more gantries (106) adapted to cause that gantry to:
i) position its corresponding pipettor over the sample container (180) in the sample presentation lane (128);
ii) aspirate the first amount of fluid from the sample container (180) in the sample presentation lane (128);
iii) position its corresponding pipettor over the target location; and iv) dispense a second amount of fluid from that gantry's corresponding pipettor into a vessel at the target location.

21. The method of claim 20, wherein the computing device (208) is configured to determine the target location by selecting from a group consisting of:
a) a sample wheel (129); and
b) a reaction build area (111).

22. The method of claim 21, wherein the set of one or more gantries consists of a single sample precision pipettor gantry (107) operable to position its corresponding pipettor over the sample presentation unit (104), the sample wheel (129) and the reaction build area (111).

23. The method of claim 21, wherein the set of one or more gantries comprises:
a) a sample aliquot pipettor gantry (105) operable to position its corresponding pipettor over the sample presentation unit (104) and the sample wheel (129) but not the reaction build area (111); and
b) a sample precision pipettor gantry (107) operable to position its corresponding pipettor over the sample presentation unit (104), the sample wheel (129) and the reaction build area (111).

24. The method of claim 20, wherein:
a) the identification information for the sample container (180) is a container type; and
b) the computing device (208) is configured to determine the container type based on container shape information captured by a camera (202) coupled to the clinical analyzer.

25. The method of claim 20, wherein:
a) the identification information for the sample container (180) is an identification of a sample in the sample container (180);
b) the computing device (208) is configured to determine the sample in the sample container (180) based on one or more of:
i) an identifier (186) on the sample container (180); and ii) a position of the sample container (180) in a sample rack (102).

26. The method of claim 20, wherein the computing device (208) is configured with instructions operable to, when executed:
a) determine whether the sample container (180) contains a pediatric sample based on the identification information for the sample container (180); and b) based on determining that the sample container (180) contains the
pediatric sample:
i) send commands to a gantry adapted to cause that gantry's corresponding pipettor to dispense fluid aspirated from the sample container (180) directly into a reaction vessel; and
ii) sending commands to a reagent pipettor of the automated clinical analyzer adapted to cause the reagent pipettor of the automated clinical analyzer to dispense a reagent into the reaction vessel.

27. The method of claim 20, wherein:
a) the computing device (208) is configured to determine a test type based on the identification information for the sample container (180); and b) the computing device (208) is configured to determine the first amount of fluid based on the determined test type.

28. The method of claim 20, wherein the computing device (208) is configured to: a) determine a test type based on identification information for the sample container (180);
b) determine whether fluid in the sample container (180) should be aliquoted into multiple portions; and
c) based on determining that fluid in the sample container (180) should be aliquoted into multiple portions, send commands to a gantry from the set of one or more gantries adapted to cause that gantry to:
i) dispense a first aliquot of fluid aspirated from the sample container (180) into a first sample vessel in a sample wheel (129); and ii) dispense a second aliquot of fluid aspirated from the sample container (180) into a second sample vessel in the sample wheel (129).

29. The method of claim 20, wherein:
a) the computing device (208) is configured with data indicating, for each of a set of one or more test types, corresponding sample handling information comprising an amount of fluid to aspirate; and
b) the computing device (208) is configured to, when the sample container (180) is determined to contain a sample to be processed using a test having a type from the set of one or more test types, determine the first amount of fluid based on the sample handling information corresponding to the type of test the sample is to be processed using.

30. The method of claim 29, wherein:
a) the computing device (208) is configured with instructions adapted to, when executed, present an interface operable by a user to specify sample handling information corresponding to a particular test type; and
b) the computing device (208) is configured to apply sample handling information specified by the user as corresponding to the particular test type to multiple samples to be processed using the particular test type without requiring the user to reenter the sample handling information for each of the multiple samples to be processed using the particular test type.

31. The method of claim 20, wherein the computing device (208) is configured to determine the first amount of fluid based on a test order for a sample in the sample container (180).

32. The method of claim 20, wherein the computing device (208) is configured to determine the first amount of fluid by performing steps comprising:
a) determining a number of aliquots to create from a sample in the sample container (180); and
b) determining a volume of fluid sufficient for each of the determined number of aliquots.

33. The method of claim 32, wherein the computing device (208) is configured to determine the volume of fluid sufficient for each of the determined number of aliquots based on combining a usable volume for each aliquot with a dead space amount for each aliquot.

34. The method of claim 20, wherein the first amount of fluid differs from the second amount of fluid by at least an overdraw amount.

35. The method of claim 19, wherein:
a) the computing device (208) performs the act of identifying the type for the sample container (180) in the sample presentation lane (128) based on the image of that sample container (180) captured by the camera (202) and, based on the type, differentiating downstream processing for fluid contained in the sample container (180); and
b) the computing device (208) is configured to identify the type for the sample container (180) based on container shape characteristics from the image captured by the camera (202).

36. The method of claim 35, wherein the container shape characteristics comprise container height.

37. A method of operating an automated clinical analyzer, the method comprising: a) presenting a first sample container on a sample presentation lane (128) of a sample presentation unit (104);
b) presenting a second sample container on the sample presentation lane (128) of the sample presentation unit (104);
c) using a camera (202) to capture a first image, wherein the first image depicts the first sample container,
d) using a camera (202) to capture a second image, wherein the second image depicts the second sample container;
e) a computing device (208) determining, based on the first image, a type for the first sample container,
f) the computing device (208) determining, based on the second image, a type for the second sample container;
g) based on the determined type for the first sample container, aspirating a first amount of fluid from the first sample container, wherein the first amount of fluid comprises an amount of fluid sufficient to perform an assay ordered for a sample in the first sample container and a dead space amount sufficient to fill dead space in an intermediate sample vessel; and
h) based on the determined type for the second sample container, aspirating a second amount of fluid from the second sample container, wherein the second amount of fluid comprises an amount of fluid sufficient to perform an assay ordered for a sample in the second sample container but does not comprise the dead space amount sufficient to fill dead space in the intermediate sample vessel.
